(19) United States
(12) Patent Application Publication
(10) Pub. No.: US 2015/0242076 A1
(43) Pub. Date: Aug. 27, 2015

(54) METHOD OF EDITING ONE OR MORE OBJECTS AND APPARATUS FOR SAME

(71) Applicant: Samsung Electronics Co., Ltd., Gyeonggi-do (KR)

(72) Inventors: Han-Kyung JO, Seoul (KR); Seok-Tae KIM, Daejeon (KR)

(73) Assignee: Samsung Electronics Co., Ltd.

(21) Appl. No.: 14/628,571

(22) Filed: Feb. 23, 2015

(30) Foreign Application Priority Data
Feb. 21, 2014 (KR) 10-2014-0020955

(51) Int. Cl. G06F 3/0483; G06F 3/0484; G06F 3/0488; G06F 3/0482

(52) U.S. Cl. CPC G06F 3/0483; G06F 3/0482; G06F 3/04842; G06F 3/0488

(57) ABSTRACT

Methods and apparatuses are provided for rearranging pages comprising one or more objects in an electronic device. The method includes displaying one or more pages having one or more objects on a display of the electronic device; receiving a first input; in response to the first input: displaying at least one or more objects having a same attribute in a page, wherein the at least one or more objects are next to each other; receiving a second input; in response to the second input, changing a position of the at least one or more objects; receiving a third input; and in response to the third input, rearranging the one or more pages according to the changed position.

### PRIORITY

This application claims priority under 35 U.S.C. §119(a) to Korean Application Serial No. 10-2014-0020955, which was filed in the Korean Intellectual Property Office on Feb. 21, 2014, the content of which is incorporated herein by reference.

### BACKGROUND OF THE INVENTION

1. Field of the Invention

The present disclosure relates generally to object editing, and more particularly, to an electronic device and a method in which an electronic device edits objects which can be displayed on a background screen.

2. Description of the Related Art

Mobile communication terminals have various functions, such as, for example, a function of watching TV (for example, mobile broadcasting such as Digital Multimedia Broadcasting (DMB) or Digital Video Broadcasting (DVB)), a function of reproducing music (for example, MPEG Audio Layer-3 (MP3)), a function of taking a picture, a function of accessing the Internet, and general communication functions such as voice calling or message transmission/reception.

In an electronic device, which includes a touch screen, such as, for example, a mobile phone, a tablet Personal Computer (PC), or a smart watch, a screen mode of the touch screen may be changed to a particular mode or an editing mode according to a touch input made by a user. Further, applications or execution icons corresponding to the applications displayed on a home screen of the electronic device may be automatically re-arranged according to a preference of the user.

### SUMMARY OF THE INVENTION

While the electronic device may display objects having different attributes on one screen, the electronic device does not support a function of editing objects according to each attribute. Specifically, in order to configure a desired home screen or page, a user is required to repeatedly re-arrange execution icons, or widgets, displayed on a screen again and again.

The present invention has been made to address at least the above problems and/or disadvantages and to provide at least the advantages described below. Accordingly, an aspect of the present invention provides an electronic device capable of re-arranging objects displayed on a screen based on types of user inputs and attributes of the objects, and an operation method thereof.

In accordance with an aspect of the present invention, a method is provided for rearranging pages comprising one or more objects in an electronic device. The method includes displaying one or more pages having one or more objects on a display of the electronic device; receiving a first input; in response to the first input: displaying at least one or more objects having a same attribute in a page, wherein the at least one or more objects are next to each other; receiving a second input; in response to the second input, changing a position of the at least one or more objects; receiving a third input; and in response to the third input, rearranging the one or more pages according to the changed position.

In accordance with another aspect of the present invention, an electronic device is provided for rearranging pages comprising one or more objects. The electronic device includes a display configured to display one or more pages having one or more objects; and a control module configured to: in response to a first input, control the display to display at least one or more objects having a same attribute in a page, wherein the at least one or more objects are next to each other, in response to a second input, change a position of the at least one or more objects, and in response to a third input, rearranging the one or more pages according to the changed position.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a diagram illustrating a network environment including an electronic device, according to an embodiment of the present invention;

FIG. 2 is a block diagram illustrating a control module of an electronic device, according to an embodiment of the present invention;

FIG. 3 is a flowchart illustrating an operation method of the electronic device, according to an embodiment of the present invention;

FIG. 4 is a flowchart illustrating an operation method of the electronic device, according to an embodiment of the present invention;

FIGS. 5A and 5B are diagrams illustrating an electronic device displaying objects, according to an embodiment of the present invention;

FIGS. 6A and 6B are diagrams illustrating an electronic device displaying objects, according to an embodiment of the present invention;

FIGS. 7A and 7B are diagrams illustrating an electronic device displaying objects, according to an embodiment of the present invention;

FIGS. 8A to 8D are diagrams illustrating an electronic device displaying objects, according to an embodiment of the present invention;

FIGS. 9A and 9B are diagrams illustrating an electronic device displaying objects, according to an embodiment of the present invention;

FIGS. 10A to 10C are diagrams illustrating an electronic device displaying objects, according to an embodiment of the present invention;

FIGS. 11A to 11C are diagrams illustrating an electronic device displaying objects, according to an embodiment of the present invention;

FIGS. 12A to 12C are diagrams illustrating an electronic device displaying objects, according to an embodiment of the present invention;

FIGS. 13A to 13D are diagrams illustrating an electronic device displaying objects, according to an embodiment of the present invention;

FIGS. 14A to 14D are diagrams illustrating an electronic device displaying objects, according to an embodiment of the present invention;

FIGS. 15A to 15C are diagrams illustrating an electronic device 101 displaying objects, according to an embodiment of the present invention;

FIG. 16 is a block diagram illustrating an electronic device, according to an embodiment of the present invention; and

FIG. 17 is a diagram illustrating communication protocols among a plurality of electronic devices, according to an embodiment of the present invention.

### DETAILED DESCRIPTION OF EMBODIMENTS OF THE PRESENT INVENTION

Embodiments of the present invention are described herein with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The term “include” or “may include” refers to the existence of a corresponding disclosed function, operation, or component, which can be used in various embodiments of the present invention, and does not limit one or more additional functions, operations, or components. Herein, terms such as “include” or “have” may be construed to denote a certain characteristic, number, step, operation, constituent element, component, or a combination thereof, but may not be construed to exclude the existence of or a possibility of additional characteristics, numbers, steps, operations, constituent elements, components, or combinations thereof.

The term “or”, as used herein, includes any or all of combinations of listed words. For example, the expression “A or B” may include A, may include B, or may include both A and B.

Expressions such as “first”, “second”, or the like, used herein, may modify various component elements in the embodiments but do not limit corresponding component elements. For example, the above expressions do not limit the sequence and/or importance of the corresponding elements. The expressions may be used to distinguish a component element from another component element. For example, a first user device and a second user device indicate different user devices, although both of them are user devices. Additionally, without departing from the scope of the present invention, a first component element may be named a second component element. Similarly, the second component element also may be named the first component element.

If it is described herein that one component element is “coupled” or “connected” to another component element, the first component element may be directly coupled or connected to the second component element, or a third component element may be “coupled” or “connected” between the first and second component elements. Conversely, when one component element is “directly coupled” or “directly connected” to another component element, a third component element does not exist between the first component element and the second component element.

The terms used herein describe specific embodiments of the present invention, and are not intended to limit the embodiments of the present invention. As used herein, singular forms are intended to include plural forms as well, unless the context clearly indicates otherwise.

Unless defined differently, all terms used herein, which include technical terminologies or scientific terminologies, have the same meanings as those known by a person skilled in the art to which the present invention belongs. Terms that are defined in a generally used dictionary are to be interpreted to have the meanings equal to the contextual meanings in the relevant field of art, and are not to be interpreted to have ideal or excessively formal meanings unless clearly defined herein.

An electronic device, according to various embodiments of the present invention, may be a device with a communication function. For example, the electronic device may be embodied as at least one of a smart phone, a tablet PC, a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, a wearable device (e.g., a Head-Mounted-Device (HMD) such as electronic glasses), electronic clothes, an electronic bracelet, an electronic necklace, an electronic appcessory, an electronic tattoo, or a smart watch.

According to an embodiment of the present invention, the electronic device may be embodied as a smart home appliance with a communication function. The smart home appliance may include at least one of, for example, a television, a Digital Versatile Disc (DVD) player, an audio player, a refrigerator, an air conditioner, an oven, a microwave, a washing machine, an air purifier, a set-top box, a TV box, a game console, an electronic dictionary, an electronic key, a camcorder, or an electronic frame.

According to an embodiment of the present invention, the electronic device may include at least one of a medical device (e.g., a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a vehicle infotainment device, an electronic device for a ship (e.g., a navigation device for a ships, and a gyro-compass), avionics, a security device, an automotive head unit, a robot for home or industry, an Automatic Teller Machine in a bank, or a Point Of Sales (POS) in a shop.

According to an embodiment of the present invention, the electronic device may include at least one of furniture or a part of a building/structure having a communication function, an electronic board, an electronic signature receiving device, a projector, or various measuring equipment (e.g., equipment for a water supply, electricity, gases, or radio waves). An electronic device, according to various embodiments of the present invention, may be a combination of one or more of the above described devices. Also, an electronic device, according to an embodiment of the present invention, may be a flexible device. Further, an electronic device, according to an embodiment of the present invention, is not limited to the above described devices.

Hereinafter, an electronic device is described, according to various embodiments of the present invention, with reference to the accompanying drawings. In various the embodiments described herein, the term “user” may indicate a person using an electronic device or a device (e.g., an artificial intelligence electronic device) using an electronic device.

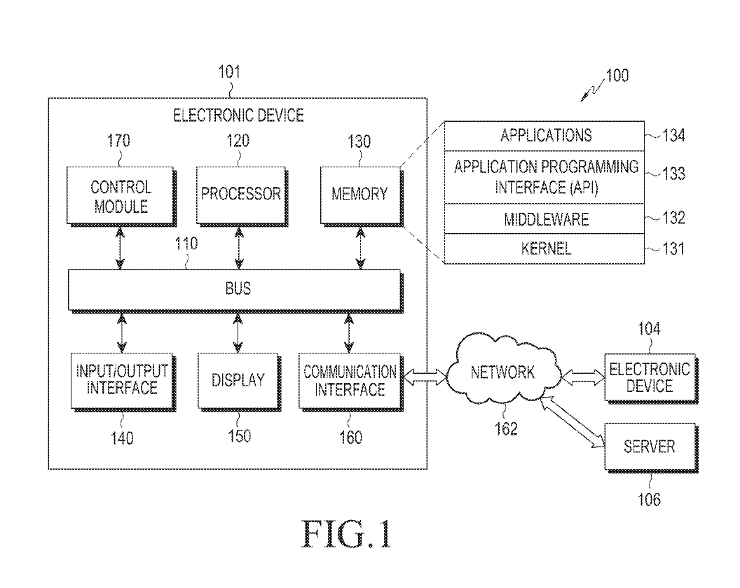

FIG. 1 is a diagram illustrating a network environment 100 including an electronic device 101, according to an embodiment of the present invention.

Referring to FIG. 1, the electronic device 101 includes a bus 110, a processor 120, a memory 130, an input/output interface 140, a display 150, a communication interface 160, and a control module 170.

The bus 110 may be embodied as a circuit to connect the above-described components with each other and to transfer communication (for example, control messages) among the above-described components.

The processor 120 may receive instructions from the above-described components (for example, the memory 130, the input/output interface 140, the display 150, the communication interface 160, and the control module 170) through, for example, the bus 110. The processor 120 then decodes the received instructions and performs calculations or data processing according to the decoded instructions.

The memory 130 may store instructions or data received from the processor 120 or other components (for example, the input/output interface 140, the display 150, the communication interface 160, and the control module 170), or instructions generated by the processor 120 or other components. The memory 130 includes programming modules such as, for example, a kernel 131, middleware 132, an Application Programming Interface (API) 133, and applications 134. Each of the programming modules described above may be formed of software, firmware, hardware, or a combination thereof.

The memory 130 may store the applications 134, the AP 133, the middleware 132, or the kernel 131 corresponding to execution icons which can be displayed on the display 150, and may also store the execution icons. Further, the memory 130 may pre-store one or more widgets which can be displayed on the display 150.

The kernel 131 may control or manage system resources (for example, the bus 110, the processor 120, or the memory 130), which are used for performing operations or functions implemented by other programming modules, for example, the middleware 132, the API 133, or the applications 134. Furthermore, the kernel 131 may provide an interface through which the middleware 132, the API 133, or the applications 134 may access individual components of the electronic device 101 to control or manage these individual components.

The middleware 132 may serve as an intermediary such that the API 133 or the applications 134 communicate with the kernel 131 to transmit/receive data. Further, in relation to requests for operations received from the applications 134, the middleware 132 may control (for example, by scheduling or load-balancing) the requests by using, for example, a method of assigning a priority by which system resources (for example, the bus 110, the processor 120, or the memory 130) of the electronic device 101 can be used for at least one application among the applications 134.

The API 133 is an interface by which the applications 134 control functions provided from the kernel 131 or the middleware 132, and may include, for example, at least one interface or function (for example, instructions) for file control, window control, image processing, text control, or the like.

According to an embodiment of the present invention, the applications 134 may include a Short Message Service (SMS)/Multimedia Messaging Service (MMS) application, an e-mail application, a calendar application, an alarm application, a health care application (for example, an application for measuring a work rate or blood sugar), an environment information application (for example, an application for providing atmospheric pressure, humidity, or temperature information). Additionally or alternatively, the applications 134 may be an application related to the exchange of information between the electronic device 101 and external electronic devices (for example, an external electronic device 104). The application related to the information exchange may include, for example, a notification relay application for transmitting specific information to the external electronic device 104, or a device management application for managing the external electronic device 104.

The notification relay application may include a function for transferring notification information generated in other applications (for example, the SMS/MMS application, the e-mail application, the health care application, or the environmental information application) of the electronic device 101 to the external electronic device 104. Additionally or alternatively, the notification relay application may receive notification information from, for example, the external electronic device 104, and provide the same to a user. The device management application, for example, may manage (for example, install, delete, or update) at least some functions (for example, turning on or off the external electronic device 104, or adjusting the brightness (or resolution) of a display) of the external electronic device 104, applications performed in the external electronic device 104, or services (for example, a phone call service, or a messaging service) provided in the external electronic device 104.

According to an embodiment of the present invention, the applications 134 may include applications, which are designated according to the property of the external electronic device 104 (for example, a type of the electronic device 104). For example, when the external electronic device 104 is an MP3 player, the applications 134 may include an application related to reproduction of music. Similarly, when the external electronic device 104 is a mobile medical device, the applications 134 may include an application related to health care. According to an embodiment of the present invention, the applications 134 may include applications designated in the electronic device 101 and/or applications received from a server 106 or the external electronic device 104.

The input/output interface 140 may transfer instructions or data input by a user through an input/output device (for example, a sensor, a keyboard, or a touch screen) to the processor 120, the memory 130, the communication interface 160, or the control module 170 through, for example, the bus 110. For example, the input/output interface 140 may provide the processor 120 with data for a user's touch, which is input through the touch screen. Further, the input/output interface 140 may output the instructions or data received, through, for example, the bus 110, from the processor 120, the memory 130, the communication interface 160, or the control module 170, through the input/output device (for example, a speaker or a display). The input/output interface 140 may output voice data processed through the processor 120 to a user through a speaker.

According to an embodiment of the present invention, the input/output interface 140 may receive a user input for editing objects (e.g., execution icons, widgets, or pages including the icons or the widgets) displayed through the display 150.

The display 150 may display various pieces of information (for example, multimedia data or text data) for the user.

The display 150 may be implemented in a form that includes a touch panel and may receive a user input made by the user. The touch panel may recognize a touch input through at least one of a capacitive type, a resistive type, an infrared type, and an ultrasonic type. That is, the display 150 may receive a user input from the user through the touch panel. Further, the display 150 may operate in accordance with the user input under a control of the control module 170. For example, the display 150 may display one or more execution icons or widgets under the control of the control module 170. The display 150, implemented in the form of the touch panel, may receive a user input for editing objects (for example, execution icons, widgets, pages including execution icons, or pages including widgets) included in one or more screens.

The communication interface 160 may connect communication between the electronic device 101 and the external device 104 or the server 160. For example, the communication interface 160 may be connected with a network 162, through wireless communication or wired communication, to communicate with the external electronic device 104 or the server 106. The wireless communication may include at least one of, for example, Wi-Fi, Bluetooth (BT), Near Field Communication (NFC), Global Positioning System (GPS), and cellular communication (for example, Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), Global System for Mobile communications (GSM), or the like). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment of the present invention, the network 162 may be a telecommunication network. The communication network may include at least one of a computer network, the Internet, the Internet of things, and a telephone network. According to an embodiment of the present invention, a protocol (for example, a transport layer protocol, data link layer protocol, or a physical layer protocol) for communication between the electronic device 101 and the external electronic device 106 may be supported in at least one of the applications 134, the API 133, the middleware 132, the kernel 131, and the communication interface 160.

The control module 170 may process at least some of the information acquired from other components (for example, the processor 120, the memory 130, the input/output interface 140, and the communication interface 160), and may provide the processed information to the user through various methods. For example, the control module 170 may control at least some functions of the electronic device 101 such that the electronic device 101 may interwork with other electronic devices (for example, the electronic device 104 or the server 106) by using the processor 120, or independently therefrom.

The control module 170 may control the display 150, implemented in the form of the touch panel, to display a page including objects which can be displayed on one screen (for example, a background screen) by the electronic device 101, for example, execution icons or widgets corresponding to applications which can be executed. The page may correspond to a screen unit displayed on the display 150. For example, each of the one or more pages included in the background screen may include and display one widget or include and display one to four execution icons.

When a user input is made through the input/output interface 140 or the display 150 implemented in the form of the touch panel, the control module 170 may edit objects included in each of the one or more pages, for example, one or more execution icons or widgets according to the user input. For example, the control module 170 may add or delete one or more execution icons to or from the background screen, and may change an arrangement order of the icons. Further, the control module 170 may add or delete the page, including one or more execution icons or widgets, to or from the background screen and may change an arrangement order of the pages.

According to an embodiment of the present invention, the control module 170 may group objects included in one or more pages, for example, execution icons or widgets. The grouping may refer to gathering objects having the same attribute. For example, it is assumed that a total of four execution icons can be displayed on one page. Further, it is assumed that the background screen of the electronic device 101 includes five pages, on three of which there is a single execution icon and on each of the remaining two pages there is a widget. The control module 170 may group three execution icons by displaying, on one page, all three execution icons included on the three pages, according to a user input made through the input/output interface 140 or the display 150. Further, in the case of the widgets, each of which is on one page, the control module 170 may control the electronic device 101 to display pages including the widgets to be close to each other by gathering the pages including the widgets.

As described above, the control module 170 may edit the pages by grouping the execution icons or widgets. The control module 170 may edit original execution icons and pages in such a manner that one page may include a maximum of four execution icons. Further, the control module 170 may collect pages including widgets based on the fact that one page includes one widget. For example, the control module 170 may edit execution icons, widgets, or pages by allowing the pages including the execution icons to be close to each other and allowing the pages including the widgets to be close to each other through grouping. For example, when it is assumed that the pages including the execution icons correspond to first to third pages, and the pages including the widgets correspond to fourth and fifth pages, the control module 170 may arrange the pages to sequentially display the first page, the second page, the third page, the fourth page, and the fifth page through grouping.

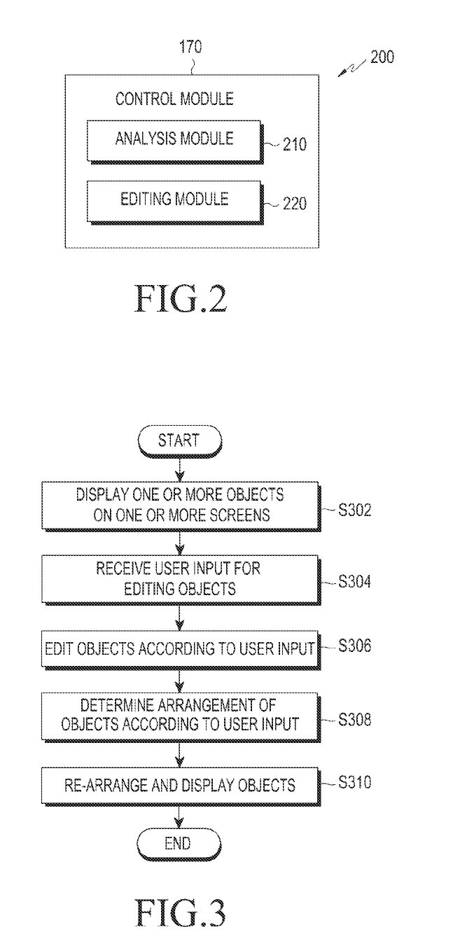

The control module 170 is described in greater detail below with reference to FIGS. 2 to 15.

FIG. 2 is a block diagram 200 illustrating the control module 170 of the electronic device 101, according to an embodiment of the present invention.

Referring to FIG. 2, the control module 170 includes an analysis module 210 and an editing module 220.

The analysis module 210 may analyze user input made through the input/output interface 140 or the display 150. The analysis module 210 may determine an operation of the electronic device 101 corresponding to the user input by analyzing the user input. The user input may be, for example, an input for adding, deleting, or changing an execution icon or a widget, or an input for adding, deleting, or changing a page. Changing the execution icon, the widget, or the page may refer to changing a position of each of the execution icon, the widget, and the page, according to the user input, or grouping the execution icons or the widgets. Further, the analysis module 210 may analyze whether the user input is an input for configuring a group of objects having the same attribute or an input for releasing the group.

The editing module 220 may edit pages displayed through the display 150. For example, the editing module 220 may change the arrangement of pages. Further, the editing module 220 may add a new page or delete one or more pages. When a new page is added, the editing module 220 may determine a position of the new page to determine the arrangement of pages including the new page.

When a user input made through the analysis module 210 is a request for adding a page, the editing module 220 may determine whether an empty page will be created according to the user input. When the empty page will be created, the analysis module 210 may not generate a new page in order to prevent the creation of the empty page. According to an embodiment of the present invention, the editing module 220 may maintain the existing pages without generating a new page. For example, it is assumed that the user makes a request for generating a new page including a particular execution icon that is currently included on a particular page. When the new page including the particular execution icon is generated, the editing module 220 may determine whether the particular page that previously included the particular execution icon becomes an empty page. When the particular page becomes the empty page, the editing module 220 may not generate the new page and may control the electronic device 101 to keep the particular execution icon included on the particular page.

The editing module 220 may edit objects, for example, execution icons, widgets, or pages that include the execution icons or the widgets according to the number of touches or a touch input scheme of the user input (for example, touch input). According to an embodiment of the present invention, a page corresponding to a home screen among the pages included on the background screen may be configured so that they are not to be edited by the editing module 220. Further, the page corresponding to the home screen may be arranged to be the first among all of the pages. The editing module 220 may edit objects included in the background screen by adding, deleting, grouping the objects included in the remaining pages, except for the home screen, or rearranging the pages.

In accordance with an aspect of the present invention, an electronic device is provided for rearranging pages comprising one or more objects. The electronic device includes a display configured to display one or more pages having one or more objects; and a control module configured to: in response to a first input, control the display to display at least one or more objects having a same attribute in a page, wherein the at least one or more objects are next to each other, in response to a second input, change a position of the at least one or more objects, and in response to a third input, rearranging the one or more pages according to the changed position.

FIG. 3 is a flowchart illustrating an operation method of the electronic device 101, according to an embodiment of the present invention.

Referring to FIG. 3, the display 150 displays one or more objects on one or more pages under a control of the control module 170, in step S302. The page may refer to an entire screen displaying all contents that can be displayed on a touch panel at the same time. For example, a lock screen may be one page. The objects may be contents that can be displayed through the display 150, and may include, for example, execution icons corresponding to applications that can be executed by the electronic device 101, or one or more widgets that are being executed in the page.

In step S302, the objects, for example, execution icons or widgets, may be displayed in one or more pages of the electronic device 101. According to an embodiment of the present invention, one to four execution icons may be included on one page. Further, only one widget may be included on one page. Since each of the widgets is included on only one page, the widget and the execution icon cannot be included on the same page. Accordingly, the page displaying one to four execution icons or the page displaying one widget may be displayed on the display 150 of the electronic device 101.

After the page is displayed, the electronic device 101 receives a user input for editing the objects, in step S304. The user input for editing the objects may include a user input for configuring groups of the execution icons, or a user input for configuring groups of the widgets. Further, the electronic device 101 may receive a user input for changing a display order or an arrangement order of pages that include the execution icons or pages that include the widgets. The analysis module 210 may determine an operation of the electronic device 101 corresponding to the user input by analyzing the user input received in step S304.

In step S304, the electronic device 101 may receive a user input for changing the arrangement of the objects. In step S304, the electronic device 101 may receive a user input for adding or deleting one or more objects, and may receive a user input for grouping objects having the same attribute.

In step S306, the control module 170 of the electronic device 101 edits (for example, add, delete, or change positions of) objects, for example, execution icons, widgets, or pages, according to the received user input received. When the editing of the objects is completed, the control module 170 determines the arrangement of the objects, in step S308. For example, the control module 170 may re-arrange the grouped objects by changing page orders from “page including execution icon”-“page including execution icon”-“page including widget”-“page including execution icon”-“page including widget”-“page including execution icon”, to “pages including execution icons”-“pages including widgets”.

When the arrangement of the objects is determined, the control module 170 re-arranges and displays the objects through the display 150, in step S310.

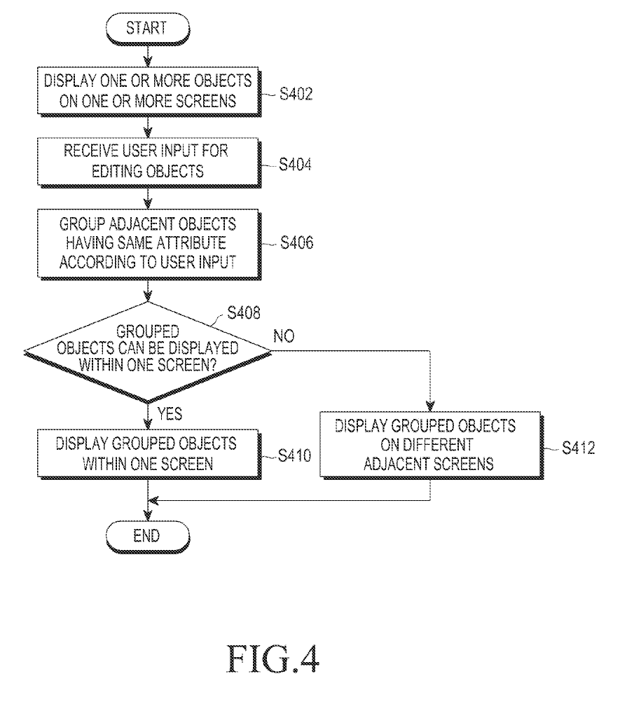

FIG. 4 is a flowchart illustrating an operation method of the electronic device 101, according to an embodiment of the present invention.

Referring to FIG. 4, the control module 170 displays one or more objects on one or more screens (pages) through the display 150, in step S402. A user input for editing the objects is input into the electronic device 101, in step S404. The user input may be a user input for configuring groups of the objects. The grouping of the objects refers to displaying objects having the same attribute to be close to each other. The control module 170 may group objects based on, for example, an application, a widget, an application being executed currently, or an application recently used.

In step S406, the control module 170 groups adjacent objects having the same attribute according to the user input. According to an embodiment of the present invention, the control module 170 determines whether all of the grouped objects can be displayed on one screen (page), in step S408.

When all of the grouped objects (for example, execution icons) can be displayed in one screen, the control module 170 controls the display 150 to display the grouped objects on one screen, in step S410. When all the grouped objects cannot be displayed on one screen, the control module 170 controls the display 150 to display the grouped objects on another adjacent page, in step S412.

In accordance with an aspect of the present invention, a method is provided for rearranging pages comprising one or more objects in an electronic device. The method includes displaying one or more pages having one or more objects on a display of the electronic device; receiving a first input; in response to the first input: displaying at least one or more objects having a same attribute in a page, wherein the at least one or more objects are next to each other; receiving a second input; in response to the second input, changing a position of the at least one or more objects; receiving a third input; and in response to the third input, rearranging the one or more pages according to the changed position.

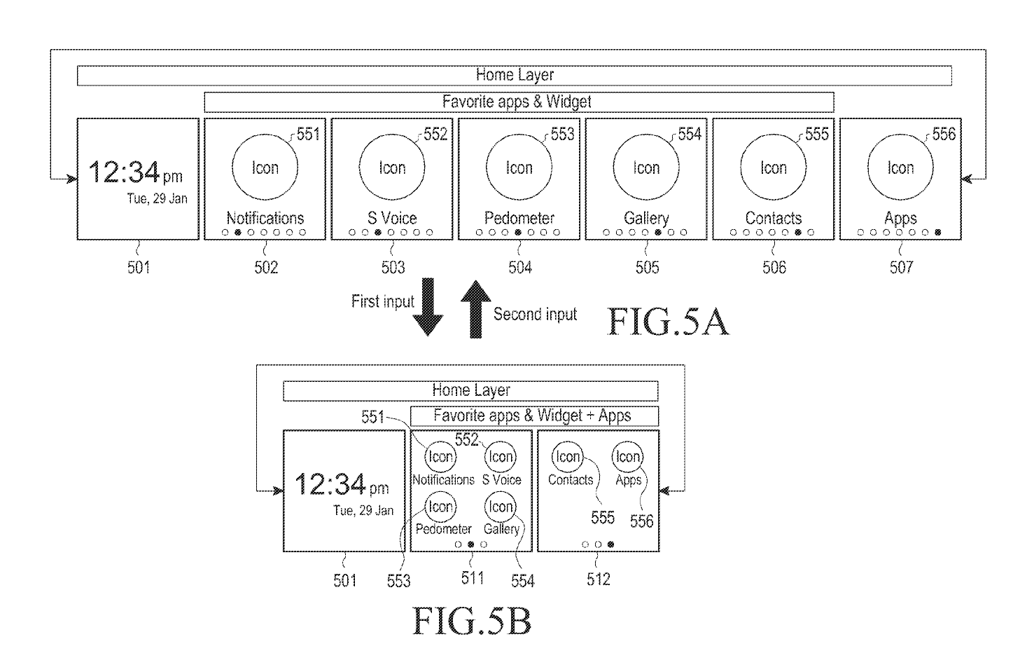

FIGS. 5A and 5B are diagrams illustrating the displaying of objects on the electronic device 101, according to an embodiment of the present invention. In FIGS. 5A and 5B, it is assumed that the control module 170 may group execution icons such that one to four execution icons are included on one page.

FIG. 5A illustrates pages that each include one execution icon or one widget. Referring to FIG. 5A, the display 150 displays first to seventh pages 501, 502, 503, 504, 505, 506, and 507. In FIG. 5A, the pages 501 to 507 may be sequentially viewed from left to right, according to a user input. Accordingly, the first to seventh pages 501 to 507 may be displayed according to the order of “first page 501→second page 502→third page 503→fourth page 504→fifth page 505→sixth page 506→seventh page 507→first page 501”, or displayed according to the opposite order thereof.

Among the first to seventh pages 501 to 507, the first page 501 is a home screen and may include a date and a time. Further, the second to seventh pages 502 to 507 may be included in a group “Favorite apps & Widget”. The second to seventh pages 502 to 507 include a first icon 551, a second icon 552, a third icon 553, a fourth icon 554, a fifth icon 555, and a sixth icon 556, respectively. The first icon 551 corresponds to the Notifications application, the second icon 552 corresponds to the S Voice application, the third icon 553 corresponds to the Pedometer application, the fourth icon 554 corresponds to the Gallery application, the fifth icon 555 corresponds to the Contacts application, and the sixth icon 556 corresponds to the Apps application.

When a first input for grouping the execution icons 551 to 556 is made, the control module 170 groups the execution icons 551 to 556 included in the pages 502 to 507, except for the first page 501 corresponding to the home screen. As a result of the grouping, FIG. 5B illustrates the first page 501 corresponding to the home screen, a second page 511 including the first to fourth icons 551 to 554, and a third page 512 including the fifth and sixth icons 555 and 556. Like the pages of FIG. 5A, in FIG. 5B, the pages 501, 511, and 512 may be displayed according to the order of “first page 501→second page 511→third page 512→first page 501”.

As described above, the control module 170 may group the first to sixth icons 551 to 556 into one group such as Favorite apps & Widget+Apps. According to the grouping of the icons 551 to 556, sizes of the icons 551 to 554 included in the second page 511 and fifth icon 555 and the sixth icon 556 included in the third page 512 may be reduced in size by ¼.

When a second input for releasing the grouping is made in a state where the execution icons 551 to 556 are grouped as illustrated in FIG. 5B, the control module 170 may release the grouping of the execution icons 551 to 556 illustrated in FIG. 5B. Further, the control module 170 may arrange the pages 502 to 507 including the execution icons 551 to 556 according to the order of FIG. 5A, before the grouping illustrated in FIG. 5B.

According to an embodiment of the present invention, the first input for grouping the execution icons 551 to 556 or the second input for releasing the grouping may be a touch input made by the user through the display implemented by a touch panel. The first input may be a pinch-in input and the second input may be a pinch-out input. According to another embodiment of the present invention, the user input for configuring the grouping or the user input for releasing the grouping may be a touch input or a hovering input made through the display 150 implemented by a touch panel. According to another embodiment of the present invention, the user input may be a gesture input having a voice input, a character input, or a user's gesture, which can be input through a camera module.

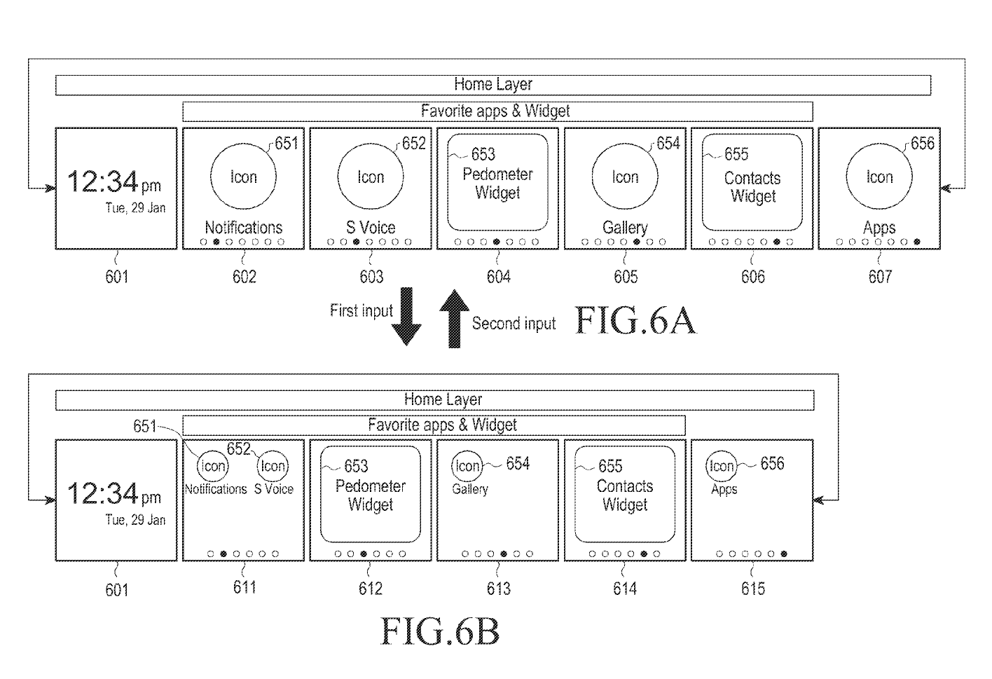

FIGS. 6A and 6B are diagrams illustrating the displaying of objects on the electronic device 101, according to an embodiment of the present invention. In FIGS. 6A and 6B, it is assumed that the control module 170 groups execution icons such that one to four execution icons are included on one page and one widget is included on one page.

FIG. 6A illustrates pages that each include one execution icon or one widget. Referring to FIG. 6A, the display 150 displays first to seventh pages 601, 602, 603, 604, 605, 606, and 607. In FIG. 6A, the pages 601 to 607 may be sequentially viewed from left to right, according to a user input. Accordingly, the first to seventh pages 601 to 607 may be displayed according to the order of “first page 601→second page 602→third page 603→fourth page 604→fifth page 605→sixth page 606→seventh page 607→first page 601”, or according to the opposite order.

Among the first to seventh pages 601 to 607, the first page 601 is a home screen and includes a date and a time. Further, the second to seventh pages 602 to 607 are included in a group “Favorite apps & Widget”. The second to seventh pages 602 to 607 include a first icon 651, a second icon 652, a first widget 653, a third icon 654, a second widget 655, and a fourth icon 656, respectively. The first icon 651 corresponds to the Notifications application, the second icon 652 corresponds to the S Voice application, the first widget 653 corresponds to a Pedometer widget, the third icon 654 corresponds to the Gallery application, the second widget 655 corresponds to a Contacts widget, and the fourth icon 656 corresponds to the Apps application.

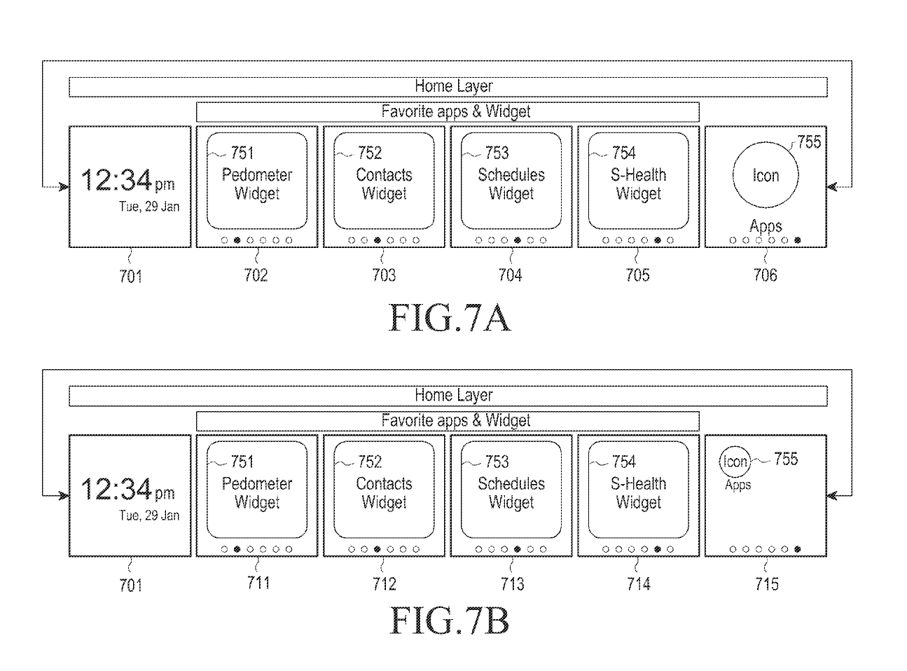

When a first input for grouping the execution icons 651, 652, 654, and 656 and the widgets 653 and 655 is made, the control module 170 groups the execution icons 651, 652, 654, and 656. The control module 170 does not group widgets, each of which is included on a single page. According to another embodiment of the present invention, when two or more widgets are included on one page, the widgets may be grouped like the execution icons. In FIG. 7B, only the execution icons 651, 652, 654, and 656 are grouped and the widgets 653 and 655 are not grouped.

As a result of the grouping, FIG. 6B illustrates the first page 601 corresponding to the home screen, a second page 611 including the first and second icons 651 and 652, a third page 612 including the first widget 653, a fourth page 613 including the third icon 654, a fifth page 614 including the second widget 654, and a sixth page 615 including the fourth icon 656. Referring to FIG. 6A, the control module 170 groups the execution icons 651 and 652 from the first page 601 to the fourth page 604, corresponding to the page including the first widget which is not a target to be grouped, so as to display the execution icons 651 and 652 on the second page 611. Further, the control module 170 determines execution icons between the first widget 653 and the second widget 654, that is, the third icon 654, as the execution icon included in one group, and displays the third icon 654 on the fourth page 613. In addition, the control module 170 groups the second widget 655 and the execution icon 656 included on the last page 607 and displays the second widget 655 and the execution icon 656 on the sixth page 615. According to the grouping of the execution icons 651, 652, 654, and 656, each of the execution icons 651 and 652 included on the second page 612, the third icon 654 included on the fourth page 613, and the fourth icon 656 included on the sixth page 615 are reduced to ¼ its original size.

In FIG. 6B, the pages 601, 611, 612, 613, 614, and 615 may be displayed according to the order of “first page 601→second page 611→third page 612→fourth page 613→fifth page 614→sixth page 615→first page 601”, or may be displayed according to the opposite order thereof.

As described above, the control module 170 may group the first to fourth icons 651, 652, 654, and 656 into one group such as Favorite apps & Widget+Apps.

When a second input for releasing the grouping is made in a state where the execution icons 651, 652, 654, and 656 are grouped as illustrated in FIG. 6B, the control module 170 may release the grouping of the execution icons 651, 652, 654, and 656 illustrated in FIG. 6B. Further, the control module 170 may arrange the pages 602, 603, 605, and 607 including the execution icons 651, 652, 654, and 656, according to the order of FIG. 6A, before the grouping illustrated in FIG. 6B.

In some embodiments, the first input for grouping the execution icons 651, 652, 654, and 656 or the second input for releasing the grouping may be a touch input made by the user through the display implemented by a touch panel. In some embodiments, the first input may be a pinch-in input and the second input may be a pinch-out input.

FIGS. 7A and 7B are diagrams illustrating the displaying of objects on the electronic device 101, according to an embodiment of the present invention. In FIGS. 7A and 7B, it is assumed that the control module 170 groups execution icons such that one to four execution icons are included on one page and one widget is included on one page.

FIG. 7A is a diagram illustrating pages that each include one execution icon or one widget. Referring to FIG. 7A, the display 150 displays first to sixth pages 701, 702, 703, 704, 705, and 706. In FIG. 7A, the pages 701 to 706 may be sequentially viewed from left to right according to a user input. Accordingly, the first to sixth pages 701 to 706 may be displayed according to the order of “first page 701→second page 702→third page 703→fourth page 704→fifth page 705→sixth page 706→first page 701”, or in the opposite order.

Among the first to sixth pages 701 to 706, the first page 701 is a home screen and includes a date and a time. Further, the second to sixth pages 702 to 706 are included in a group “Favorite apps & Widget”. The second to sixth pages 702 to 706 include a first widget 751, a second widget 752, a third widget 753, a fourth widget 754, and a first icon 755, respectively. The first widget 751 is a Pedometer widget, the second widget 752 is a Contact widget, the third widget 753 is a Schedule widget, the fourth widget 754 is an S-Health widget, and the first icon 755 corresponds to the Apps application.

When a first input for grouping the execution icon 755 and the widgets 751 to 754 is made, the control module 170 groups the execution icons included on the pages 702 to 706. The control module 170 does not group widgets, each of which is included on a singe page. In FIG. 7B, only the execution icon 755 is grouped and the widgets 751 to 754 are not grouped.

As a result of the grouping, FIG. 7B illustrates a first page 701 corresponding to the home screen, a second page 711 including the first widget 751, a third page 712 including the second widget 752, a fourth page 713 including the third widget 753, a fifth page 714 including the fourth widget 754, and a sixth page 715 including the first icon 755. Referring to FIG. 7A, the control module 170 may group one or more execution icons included on the remaining pages except for the pages from the first page 701 to the page including the widget which is not a target to be grouped, that is, from the first page 701 to the fifth page 701, 702, 703, 704, and 705. Accordingly, the control module 170 groups the first icon 755 included on the pages up to the sixth page 706, and display the first icon 755 on one page 715. According to the grouping of the execution icon, the first icon 755 included on the sixth page 715 is reduced to ¼ its original size.

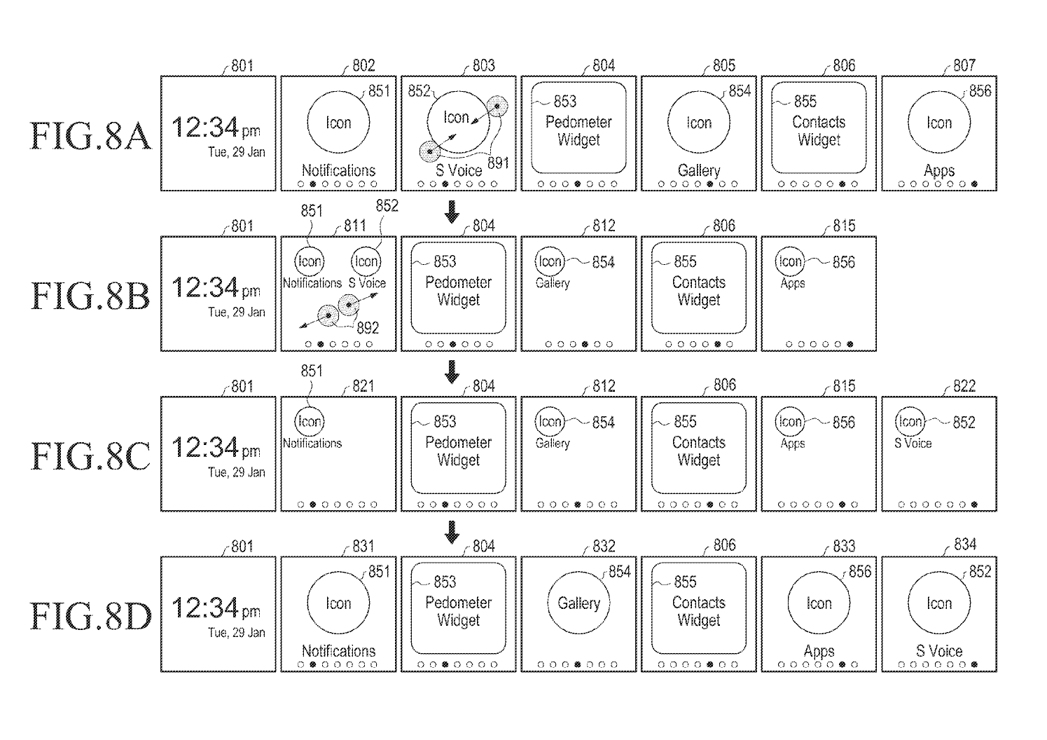

FIGS. 8A to 8D are diagrams illustrating the displaying of objects on the electronic device 101, according to an embodiment of the present invention. In FIGS. 8A to 8D, it is assumed that the control module 170 may group execution icons such that one to four execution icons are included on one page and one widget is included on one page.

FIG. 8A is a diagram illustrating pages that include one execution icon or one widget. Referring to FIG. 8A, the display 150 displays first to seventh pages 801, 802, 803, 804, 805, 806, and 807.

Among the first to seventh pages 801 to 807, the first page 801 is a home screen that includes a date and a time. The second to seventh pages 802 to 807 include a first icon 851, a second icon 852, a first widget 853, a third icon 854, a second widget 855, and a fourth icon 856, respectively.

In FIG. 8A, the electronic device 101 receives a first input 891 as a user input when the third page 803 including the second icon 852 is displayed. The first input 891 is a pinch-zoom input and configured for grouping of the execution icons 851, 852, 854, and 856.

In FIG. 8B, the first icon 851 and the second icon 852 are grouped according to the first user input 891, and the first icon 851 and the second icon 852 are reduced to ¼ their original sizes and are included and displayed in a second page 811. Further, each of the third icon 854 and the fourth icon 856 is grouped, and thus, the third icon 854 is reduced to ¼ its original size and is included and displayed on a fourth page 812, and the fourth icon 856 is reduced to ¼ its original size and is included and displayed on a sixth page 815.

In FIG. 8C, the control module 170 removes the second icon 852 of the grouped first icon 851 and second icon 852 from the second page 811 according to a second user input 892 made in the second page 811 of FIG. 8B. The second user input 892 is a pinch-out input configured to remove one of the execution icons which are grouped and included on one page from the page. According to the second user input 892, the control module 170 removes the second icon 852 from the second page 821 and includes and displays the second icon 852 on a newly generated seventh page 822.

In FIG. 8D, the grouping of the execution icons 851, 852, 854, and 856 is released. According to the release of the grouping, sizes of the execution icons 851, 852, 854, and 856 return to those shown in FIG. 8A, in pages 831, 832, 833, and 834, respectively. Further, in FIG. 8C, the second icon 852 becomes larger and is included in newly generated seventh page 834

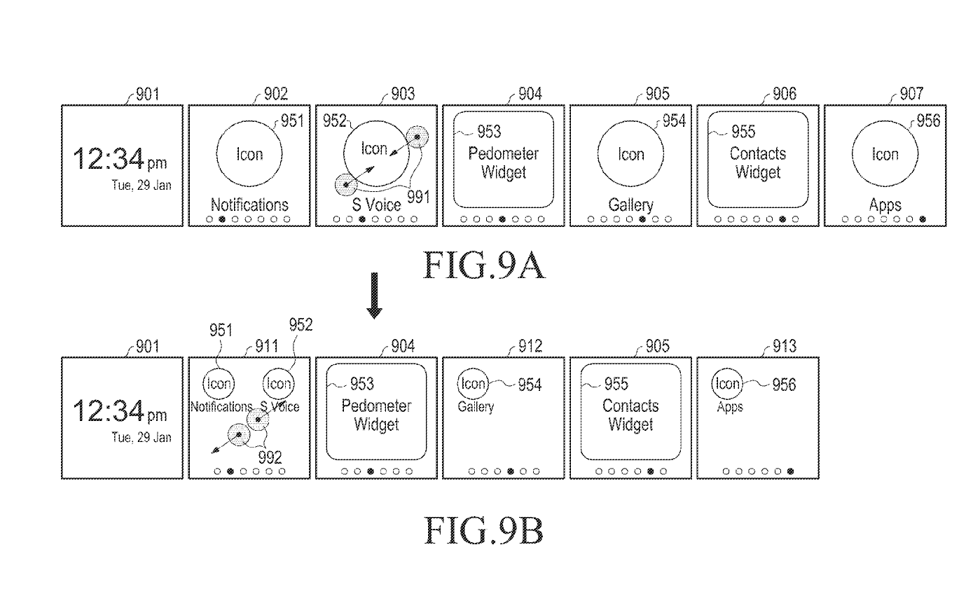

FIGS. 9A and 9B are diagrams illustrating the displaying of objects on the electronic device 101, according to an embodiment of the present invention. In FIGS. 9A and 9B, it is assumed that the control module 170 groups execution icons such that one to four execution icons are included on one page, and one widget is included in one page.

FIG. 9A illustrates pages that each include one execution icon or one widget. Referring to FIG. 9A, the display 150 displays first to seventh pages 901, 902, 903, 904, 905, 906, and 907.

Among the first to seventh pages 901 to 907, the first page 901 is a home screen that includes a date and a time. The second to seventh pages 902 to 907 include a first icon 951, a second icon 952, a first widget 953, a third icon 954, a second widget 955, and a fourth icon 956, respectively.

In FIG. 9A, the electronic device 101 receives a first input 991 as a user input when the third page 903 including the second icon 952 is displayed. The first input 991 is a pinch-zoom input configured to group the execution icons 951, 952, 954, and 956.

In FIG. 9B, the first icon 951 and the second icon 952 are grouped according to the first user input 991, and the first icon 951 and the second icon 952 are reduced to ¼ their original sizes and are included and displayed in a second page 911. Further, each of the third icon 954 and the fourth icon 956 is grouped, and thus, the third icon 954 is reduced to ¼ its original size and is included and displayed in a fourth page 912, and the fourth icon 956 is reduced to ¼ its original size and is included and displayed in a sixth page 913.

In addition, in FIG. 9B, the electronic device 101 receives a second user input 992, which is input into the second page 911 including the first icon 951 and the second icon 952. The second user input 992 is a pinch-out input configured to remove the second icon 952 from the second page 911, and release the grouping of the execution icons 951, 952, 954, and 956 at the same time.

According to the second user input 992, the control module 170 removes the second icon 952 from the second page 911. The control module 170 includes and displays the second icon 952 on the sixth page 913, as illustrated in FIG. 9B.

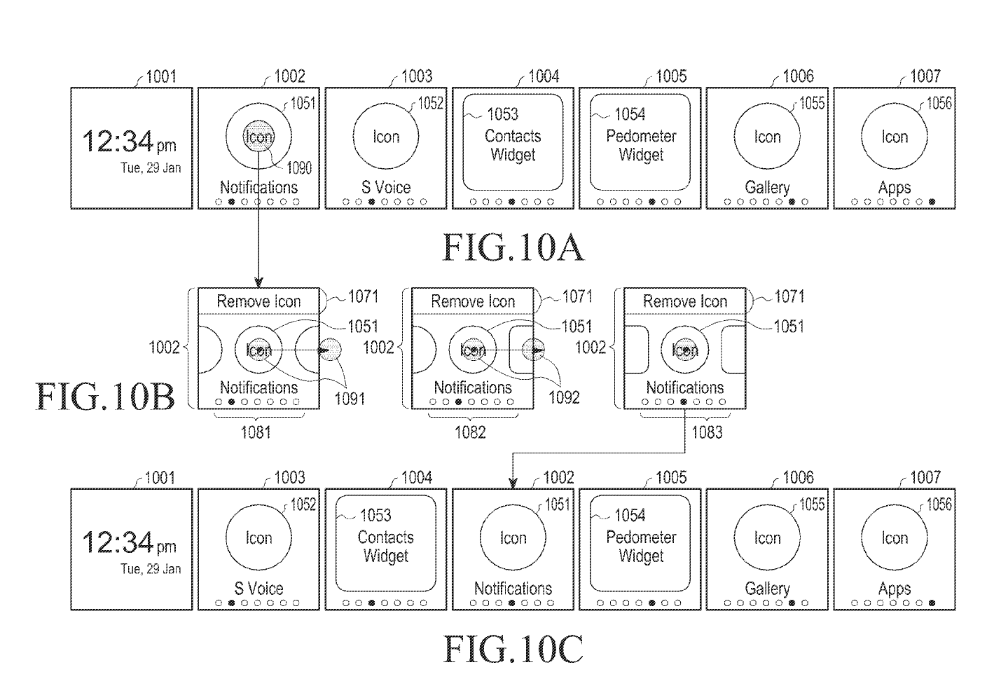

FIGS. 10A to 10C are diagrams illustrating the displaying of objects on the electronic device 101, according to an embodiment of the present invention.

FIG. 10A illustrates pages that each include one execution icon or one widget. Referring to FIG. 10A, the display 150 displays first to seventh pages 1001, 1002, 1003, 1004, 1005, 1006, and 1007.

Among the first to seventh pages 1001 to 1007, the first page 1001 is a home screen that includes a date and a time. The second to seventh pages 1002 to 1007 include a first icon 1051, a second icon 1052, a first widget 1053, a second widget 1054, a third icon 1055, and a fourth icon 1056, respectively.

FIG. 10B illustrates an editing mode of the pages 1001 to 1007. When the user makes a first input 1090 by pressing the first icon 1051 of the second page 1002, illustrated in FIG. 10A, by using a finger, for a preset time or longer, the control module 170 reduces a size of the first icon 1051 and displays the reduced first icon 1051. The first user input 1090 is configured to execute an editing mode. Further, when the editing mode is executed, as illustrated in FIG. 10B, sizes of the icons 1051, 1052, 1055, and 1056, and widgets 1053 and 1054 are reduced, an indication 1071 informing of the editing mode for editing icons, widgets, or pages is displayed on the upper ends of the pages 1001 to 1007, and page indicators 1081, 1082, and 1083 are displayed on the lower ends of the pages. The page indicators 1081, 1082, and 1083 are displayed on the lower ends of pages to indicate what page the current page displayed on the display 150 is among all of the pages. Referring to FIGS. 10A to 10C, the page indicators 1081, 1082, and 1083 are displayed in a form of arranged small circles, and a current page displayed through the display 150 is marked with a black circle.

Referring to FIG. 10B, it is noted through the page indicator 1081 that the second page 1002 is the second page of a total of seven pages. The user may move the placement of the second page 1002 within the seven pages through a user input 1091 of selecting the first icon 1051 included in the second page 1002 and swiping the selected first icon 1051 towards the right. Accordingly, the second page 1002 becomes the third page of the seven pages based on the page indicator 1082. When the user makes a user input 1092 of swiping towards the right again, the second page 1002 is moved towards the right again, and the second page 1002 becomes the fourth page of the seven pages based on the page indicator 1083.

FIG. 10C shows a result of the movements of the second page 1002 made in FIG. 10B. Referring to FIG. 10C, pages 1001 to 1007 are re-arranged in the order of “first page 1001→third page 1003→fourth page 1004→second page 1002→fifth page 1005→sixth page 1006→seventh page 1007”.

Although FIGS. 10A-10C illustrate only the movement of one page from left to right, one or more pages can move from right to left in accordance with embodiments of the present invention. Further, the user may move one or more pages up to a desired position by making a user input of selecting the one or more pages and dragging the one or more selected pages in a left or right direction in the electronic device 101. The user may make the third page 1003 a seventh page in one motion by selecting the third page 1003 illustrated in FIG. 10A and dragging the selected third page 1003 towards the right. Further, when the user makes a user input of selecting a particular page and dragging the selected particular page towards the left or right in the electronic device 101, the remaining pages except for the particular page may be displayed on the display 150 below the particular page in an overlap form. In addition, the display 150 may display the pages as if the particular page rapidly passes over the remaining pages under a control of the control module 170.

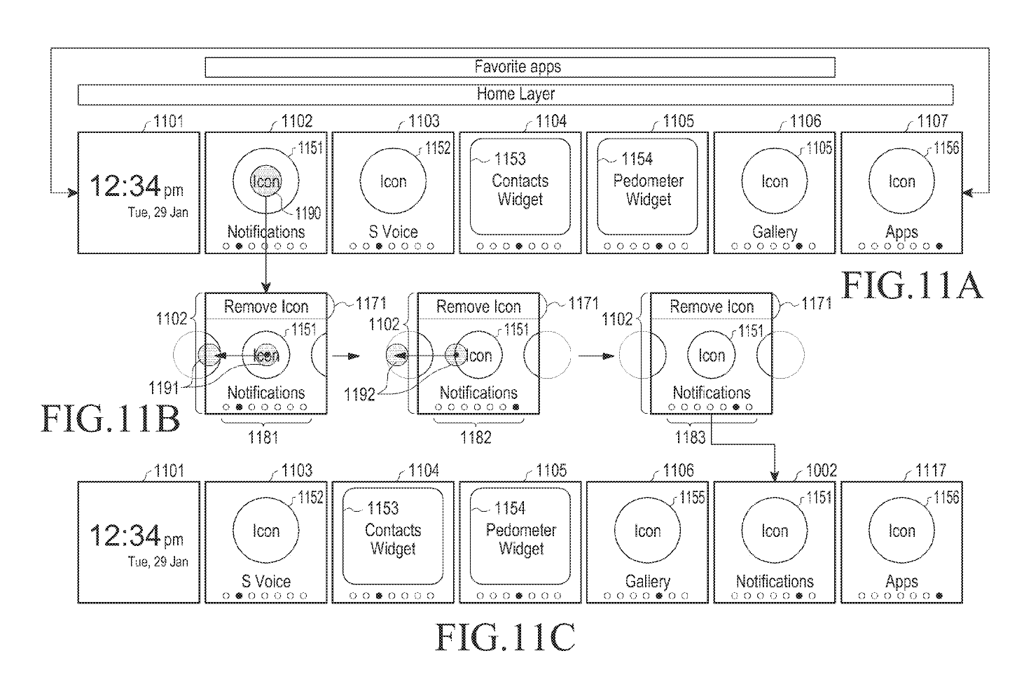

FIGS. 11A to 11C are diagrams illustrating the displaying of objects on the electronic device 101, according to an embodiment of the present invention.

FIG. 11A illustrates pages that each include one execution icon or one widget. Referring to FIG. 11A, the display 150 displays first to seventh pages 1101, 1102, 1103, 1104, 1105, 1106, and 1107.

Among the first to seventh pages 1101 to 1107, the first page 1101 is a home screen that includes a date and a time. The second to seventh pages 1102 to 1107 include a first icon 1151, a second icon 1152, a first widget 1153, a second widget 1154, a third icon 1155, and a fourth icon 1156, respectively.

FIG. 11B illustrates an editing mode of the pages 1101 to 1107. When the user makes a first input 1190 by pressing the first icon 1151 of the second page 1102 by using a finger, for a preset time or longer, the control module 170 reduces the size of the first icon 1151 of the second page 1002 and displays the reduced first icon 1151. The first user input 1190 is configured to execute an editing mode.

Further, when the editing mode is executed as illustrated in FIG. 11B, sizes of the icons 1151, 1152, 1155, and 1156, and widgets 1153 and 1154 are reduced, an indication 1171 informing of the editing mode for editing icons, widgets, or pages is displayed on the upper ends of the pages 1101 to 1107, and page indicators 1181, 1182, and 1183 are displayed on the lower ends of the pages. The page indicators 1181, 1182, and 1183 are displayed on the lower ends of pages to indicate what page the current page is among all pages.

FIG. 11B illustrates an operation in which the electronic device 101 moves the second page 1102 towards the left in the editing mode. Referring to FIG. 11B, it is noted through the page indicator 1181 that the second page 1102 is the second page of seven pages. The user makes a second user input 1191 by selecting the first icon 1151 included in the second page 1102 and swiping the selected first icon 1151 towards the left. The second user input 1191 moves the second page 1102 towards the left. In FIGS. 11A to 11C, the first page 1101 corresponding to the home screen is fixed to the first page. Accordingly, the second page 1102 cannot be the first page of the seven pages. Therefore, the second page 1102 becomes the last page of the seven pages. Referring to FIG. 11A, the first to seventh pages can be displayed in a loop form according to the order of “first page 1101→second page 1102→third page 1103→fourth page 1104→fifth page 1105→sixth page 1106→seventh page 1107→first page 1101”. Accordingly, the second page 1102 becomes the seventh of the seven pages based on the page indicator 1182 of FIG. 11B.

When the user makes a third user input 1192 of swiping the second page 1102 towards the left in the electronic device 101, the second page 1102 is moved towards the left again. Accordingly, the second page 1102 becomes the sixth of the seven pages based on the page indicator 1183. FIG. 11C shows a result of the movements of the second page 1102 made in FIG. 11B. Referring to FIG. 11C, the pages 1101 to 1107 are re-arranged in the order of “first page 1101→third page 1103→fourth page 1104→fifth page 1105→sixth page 1106→second page 1102→seventh page 1107”.

Like in FIGS. 10A to 10C, one or more pages can be moved from left to right in the editing mode. In some embodiments, the user may move one or more pages to a desired position through a user input of selecting the one or more pages and dragging the one or more selected pages towards the left or right in the electronic device 101.

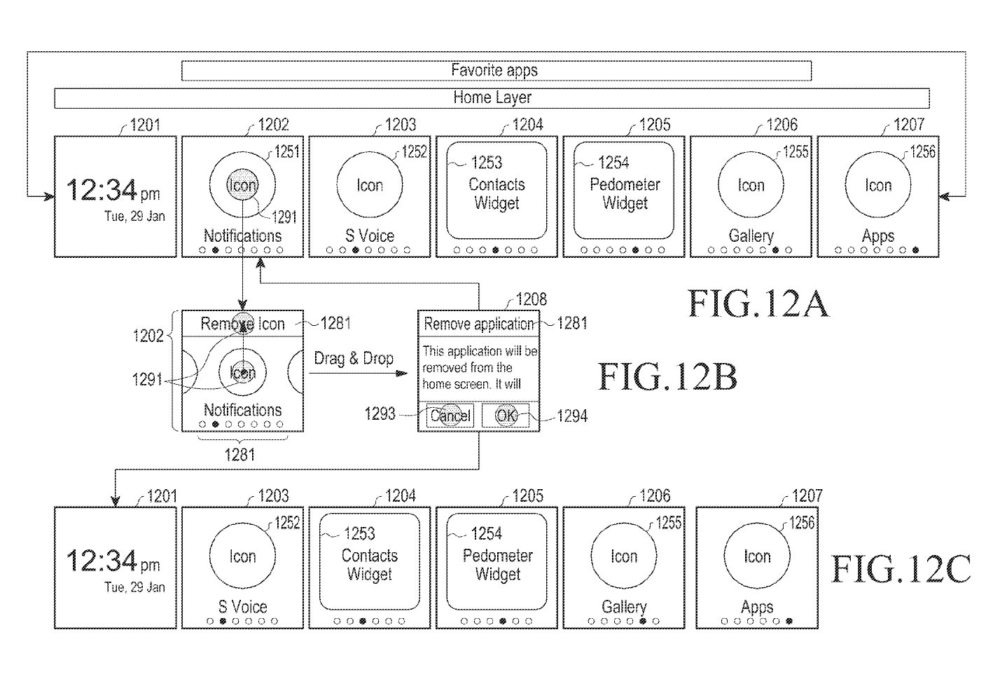

FIGS. 12A to 12C are diagrams illustrating the displaying of objects on the electronic device 101, according to an embodiment of the present invention.

FIG. 12A illustrates pages that each include one execution icon or one widget. Referring to FIG. 12A, the display 150 displays first to seventh pages 1201, 1202, 1203, 1204, 1205, 1206, and 1207.

Among the first to seventh pages 1201 to 1207, the first page 1201 is a home screen that includes a date and a time. The second to seventh pages 1202 to 1207 include a first icon 1251, a second icon 1252, a first widget 1253, a second widget 1254, a third icon 1255, and a fourth icon 1256, respectively.

FIG. 12B illustrates an editing mode of the pages 1201 to 1207. When the user makes a first input 1290 of pressing the first icon 1251 of the second page 1202 using a finger, for a preset time or longer, the control module 170 reduces the size of the first icon 1251 of the second page 1002 and displays the reduced first icon 1251. The first user input 1290 is configured to execute an editing mode.

Further, when the editing mode is executed as illustrated in FIG. 12B, sizes of the icons 1251, 1252, 1255, and 1256, and widgets 1253 and 1254 are reduced, an indication 1271 informing of the editing mode for editing icons, widgets, or pages is displayed on the upper ends of the pages 1201 to 1207, and a page indicator 1281 is displayed on the lower ends of the pages. The page indicator 1281 is displayed on a lower end of the page to indicate what page the current page is among all of the pages. FIG. 12B illustrates an operation in which the electronic device 101 removes one or more pages, for example, the second page 1202, in the editing mode.

Referring to FIG. 12B, it is noted through the page indicator 1281 that the second page 1202 is a second page of seven pages. The user makes a second user input 1291 for deleting the second page 1202 by selecting the first icon 1251 included in the second page 1202 and dragging the selected first icon 1151 in a direction of the indication 1291. The electronic device 101 displays an indication window 1208 to inquire whether to remove the second page 1202. The user may remove the second page 1202 or cancel the request for removing the second page 1202 by selecting one of two buttons 1293 and 1294 included in the indication window 1208, as illustrated in FIG. 12B.

When the user makes a user input for selecting the first button 1293 in the electronic device 101, the second page 1202 is maintained without being removed. When the user makes a user input for selecting the second button 1294 in the electronic device 101, the second page 1202 is removed.

FIG. 12C shows a result of the removal of the second page 1202 made in FIG. 12B. Referring to FIG. 12C, the remaining pages 1201 to 1207 are re-arranged in the order of “first page 1201→third page 1203→fourth page 1204→fifth page 1205→sixth page 1206→seventh page 1207”.

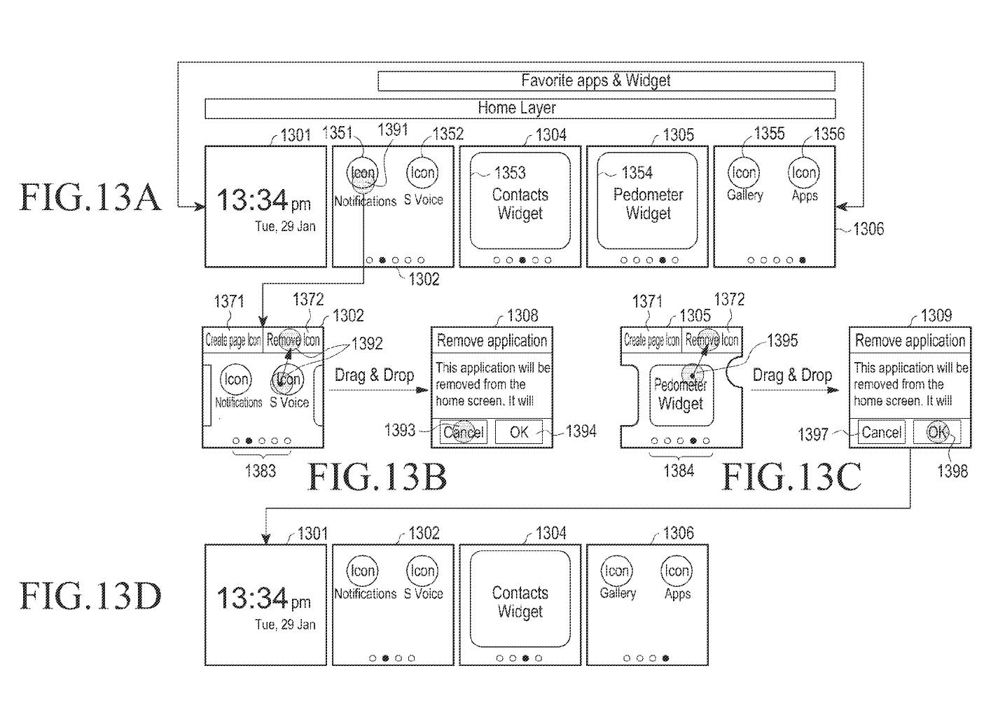

FIGS. 13A to 13D are diagrams illustrating the displaying of objects on the electronic device 101, according to an embodiment of the present invention.

FIGS. 13A to 13D illustrate the removal of pages when icons are grouped. Referring to FIG. 13A, the display 150 displays first to fifth pages 1301, 1302, 1304, 1305, and 1306.

Among the first to fifth pages, the first page 1301 is a home screen that includes a date and a time. The second page includes a first icon 1351 and a second icon 1352, the third page 1304 includes a first widget 1353, the fourth page 1305 includes a second widget 1354, and the fifth page 1306 includes a third icon 1355 and a fourth icon 1356.

FIG. 13B illustrates an editing mode of the pages 1301 to 1306. When the user makes a first input 1391 of pressing the first icon 1351 of the second page 1302 by using a finger, for a preset time or longer, the control module 170 reduces the size of the icons and the widgets included in the pages 1301 to 1306 and displays the reduced icons and widgets. The first user input 1391 is configured to execute an editing mode.

Further, when the editing mode is executed as illustrated in FIG. 13B, sizes of the icons 1351, 1352, 1355, and 1356, and widgets 1353 and 1354 are reduced, editing menus 1371 and 1372 informing of the editing mode for editing icons, widgets, or pages are displayed on the upper ends of the pages 1301 to 1306, and page indicators 1383 are displayed on the lower ends of the pages. FIG. 13B illustrates an operation in which the electronic device 101 removes one or more pages, for example, the second page 1302 in an editing mode. Referring to FIG. 13B, it is noted through the page indicator 1383 that the second page 1302 is the second of five pages.

The user makes a request for removing the second page 1302 by selecting the second icon 1352 and dragging the selected second icon 1352 in a direction of the editing menu 1372. The electronic device 101 displays an indication window 1308 to inquire whether to remove the second icon 1352. The user may remove the second icon 1352 or cancel the request for removing the second icon 1352 by selecting one of two buttons 1393 and 1394 included in the indication window 1308 illustrated in FIG. 13B. When the user makes a user input for selecting the first button 1393 in the electronic device 101, the second icon 1352 is maintained without removal. When the user makes a user input for selecting the second button 1394 in the electronic device 101, the second icon 1352 is removed. As shown in FIG. 13B, the user makes a determination to maintain the second icon without removal.

FIG. 13C also illustrates the editing mode of the pages 1301 to 1306. In FIGS. 13A and 13C, the user makes a request 1395 for removing the fourth page 1304, that is, the second widget 1354 to the electronic device 101. Referring to FIG. 13C, it is noted through the page indicator 1384 that the fourth page 1305 is the fourth of five pages. The user may make a request for removing the second widget 1354 by dragging the second widget 1354 in a direction of the editing menu 1372. The electronic device 101 displays an indication window 1309 to inquire whether to remove the second widget 1354. The user may remove the second widget 1354 or cancel the request for removing the second widget 1354 by selecting one of two buttons 1397 and 1398 included in the indication window 1309 illustrated in FIG. 13C. For example, when the user makes a user input for selecting the first button 1397 in the electronic device 101, the second widget 1354 is maintained without removal. When the user makes a user input for selecting the second button 1398 in the electronic device 101, the second widget 1354 is removed. In FIG. 13C, the second button 1398 is selected to remove the second widget 1354. Accordingly, the fourth page 1305 including the second widget 1354 is removed.

FIG. 13D illustrates a result of the maintaining of the second icon 1352 and the removal of the second widget 1354 made in FIGS. 13B and 13C. Referring to FIG. 13D, the pages 1301 to 1306 are re-arranged in the order of “first page 1301→second page 1302→third page 1304→fifth page 1306”.

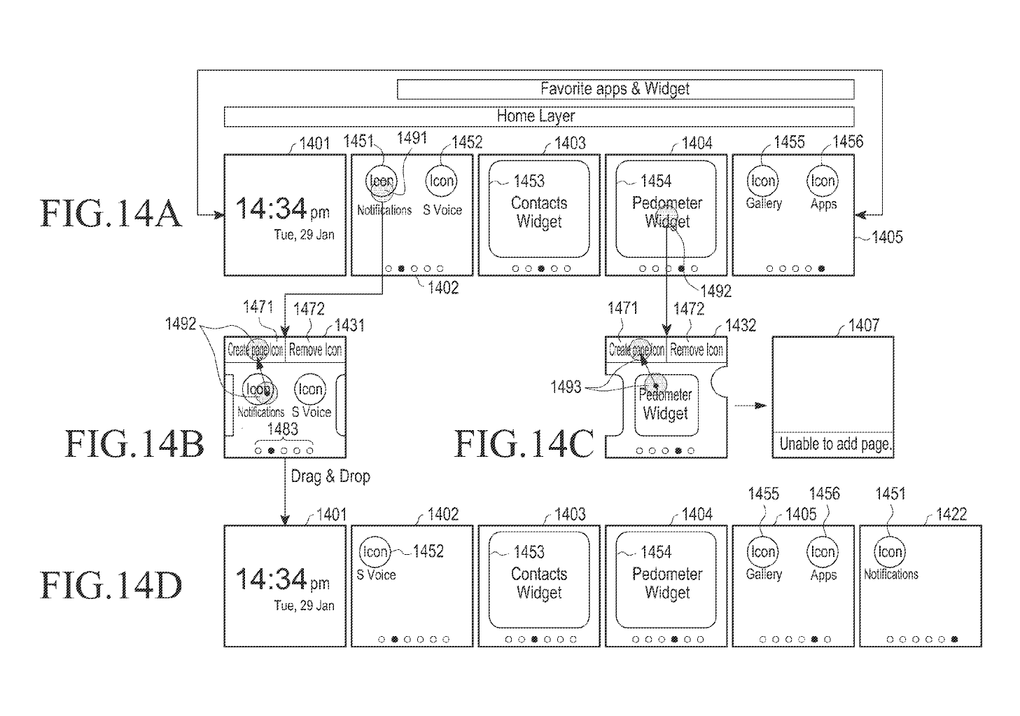

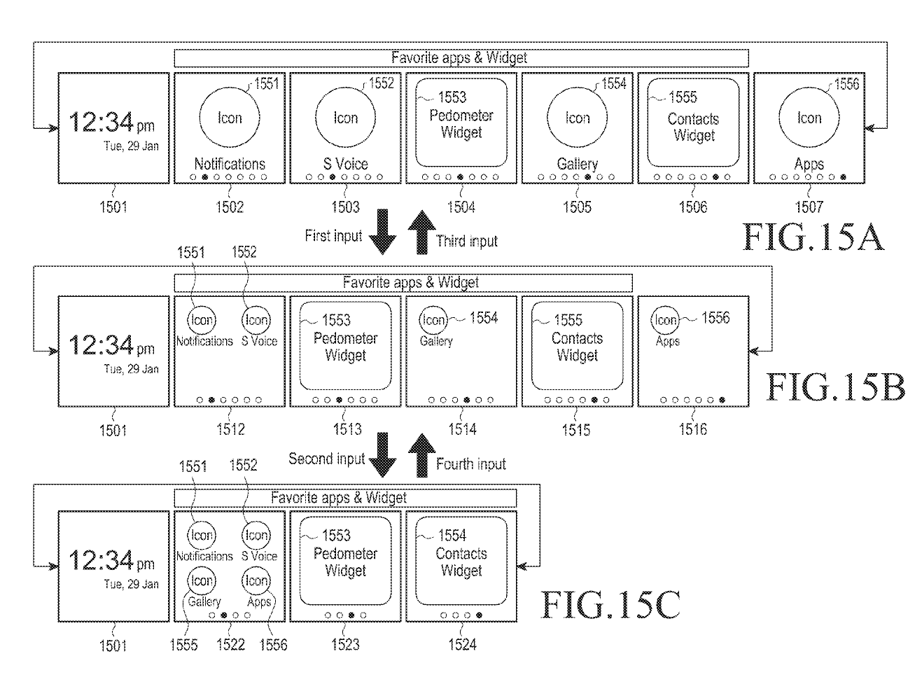

FIGS. 14A to 14C are diagrams illustrating the displaying of objects on the electronic device 101 according to an embodiment of the present invention.

FIGS. 14A to 14D illustrate page addition in a state where icons are grouped.

Referring to FIG. 14A, the display 150 displays first to fifth pages 1401, 1402, 1403, 1404, and 1405.

Among the first to fifth pages 1401 to 1405, the first page 1401 is a home screen that includes a date and a time. The second page 1402 includes a first icon 1451 and a second icon 1452, the third page 1403 includes a first widget 1453, the fourth page 1404 includes a second widget 1454, and the fifth page 1405 includes a third icon 1455 and a fourth icon 1456.

FIG. 14B illustrates an editing mode of the pages 1401 to 1405. When the user makes a first input 1491 of pressing the first icon 1451 of the second page 1402 by using a finger, for a preset time or longer, the control module 170 reduces the sizes of the execution icons and the widgets included in the pages 1401 to 1405, and displays the reduced execution icons and widgets. The first user input 1491 is configured to execute an editing mode. Further, when the editing mode is executed as illustrated in FIG. 14B, sizes of the execution icons 1451, 1452, 1455, and 1456, and widgets 1453 and 1454 are reduced, editing menus 1471 and 1472 informing of the editing mode for editing icons, widgets, or pages is displayed on the upper ends of the pages 1401 to 1405, and a page indicator 1483 is displayed on the lower ends of the pages. FIG. 14B illustrates an operation in which the electronic device 101 generates one or more pages, for example, a sixth page in an editing mode. Referring to FIG. 14B, it is noted through the page indicator 1483 that the second page 1402 is a second of five pages. The user makes a request for generating a new page including the first icon 1451, which is included on the second page 1402, by selecting the first icon 1451 included in the second page 1431 and dragging the selected first icon 1451 in a direction of the editing menu 1471, as shown by 1492.

FIG. 14C also illustrates the editing mode of the pages 1401 to 1405. In FIGS. 14A and 14C, the user makes request 1493 for generating a new page including the second widget 1454 of the fourth page 1432 to the electronic device 101. However, the widget may only be included on one page. Accordingly, if the new page including the second widget 1454 is generated, the fourth page 1404 which had included the second widget 1454 has no widget and no execution icon. That is, if the new page including the second widget is generated, the fourth page becomes an empty page. In FIG. 14A to 14C, when an empty page would be generated, the control module 170 controls the electronic device 101 not to generate the empty page. Accordingly, the control module 170 controls the electronic device not to generate the new page including the second widget 1454. Although the user makes a request for generating the new page including the second widget 1454, the electronic device 101 informs the user through the indication window 1407 that the new page cannot be generated.

FIG. 14D illustrates a result of the addition of the new page made in FIG. 14B. Referring to FIG. 14D, a sixth page 1422 including the first icon 1451 is added to the existing pages 1401 to 1405. Accordingly, it is noted that the pages are arranged in the order of “first page 1401→second page 1402→fourth page 1404→fifth page 1405→sixth page 1422”.

FIGS. 15A to 15C are diagrams illustrating the displaying of objects on the electronic device 101, according to an embodiment of the present invention. In FIGS. 15A to 15C, it is assumed that the control module 170 groups icons such that one to four icons are included on one page and only one widget is included on one page.

FIG. 15A illustrates pages that each include one execution icon or one widget. Referring to FIG. 15A, the display 150 displays first to seventh pages 1501, 1502, 1503, 1504, 1505, 1506, and 1507. In FIG. 15A, the pages 1501 to 1507 may be sequentially turned from left to right by a user input. Accordingly, the first to seventh pages 1501 to 1507 may be displayed according to the order of “first page 1501→second page 1502→third page 1503→fourth page 1504→fifth page 1505→sixth page 1506→seventh page 1507→first page 1501”. Further, the first to seventh pages may be displayed according to the opposite order.

Among the first to seventh pages 1501 to 1507, the first page 1501 is a home screen that includes a date and a time. Further, the second to seventh pages 1502 to 1507 are included in a group “Favorite apps & Widget”. The second to seventh pages 1502 to 1507 include a first icon 1551, a second icon 1552, a first widget 1553, a third icon 1554, a second widget 1555, and a fourth icon 1556, respectively. The first icon 1551 corresponds to the Notifications application, the second icon 1552 corresponds to the S Voice application, the first widget 1553 is a Pedometer widget, the third icon 1554 corresponds to the Gallery application, the second widget 1555 is a Contacts widget, and the fourth icon 1556 corresponds to the Apps application.

When a first input for grouping the execution icons 1551, 1552, 1554, and 1556 and the widgets 1553 and 1555 is made, the control module 170 groups the execution icons 1551, 1552, 1554, and 1556. The control module 170 does not group widgets, each of which is included on one page.

In FIG. 15B, the execution icons 1551, 1552, 1554, and 1556 are grouped and the widgets 1553 and 1555 are not grouped. As a result of the grouping, FIG. 15B illustrates the first page 1501 corresponding to the home screen, a second page 1512 including the first and second icons 1551 and 1552, a third page 1513 including the first widget 1553, a fourth page 1514 including the third icon 1554, a fifth page 1514 including the second widget 1555, and a sixth page 1516 including the fourth icon 1556.

Referring to FIG. 15A, the control module 170 may group the execution icons 1551 and 1552 from the first page 1501 to the fourth page 1504 corresponding to the page including the first widget which is not a target to be grouped, so as to display the execution icons 1551 and 1552 on one page 1512. Further, the control module 170 may determine icons between the first widget 1553 and the second widget 1555, that is, the third icon 1554, as the icon included in one group and display the third icon 1554 in the fourth page 1514. In addition, the control module 170 may group the second widget 1555 and the execution icon 1556 included on the last page 1507, and may display the second widget 655 and the execution icon 1556 on one page 1516. According to the grouping of the icons 1551, 1552, 1554, and 1556, each of the icons 1551 and 1552 included in the second page 1512, the third icon 1554 included in the fourth page 1514, and the fourth icon 1556 included in the sixth page 1516 are reduced to ¼ its original size. As described above, the primary grouping is for icons included in pages adjacent to each other, and there may be no page including the widget between the pages.

As in FIG. 15A, the pages 1501, 1512, 1513, 1514, 1515, and 1516 of FIG. 15B are displayed according to the order of “first page 1501→second page 1512→third page 1513→fourth page 1514→fifth page 1515→sixth page 1516→first page 1501”, or may be displayed according to the opposite order thereof.

As described above, the control module 170 groups the first to fourth icons 1551, 1552, 1554, and 1556 into one group, such as Favorite apps & Widget+Apps.

When a second input (for example, a pinch-out input) for releasing the primary grouping is made in a state where the icons 1551, 1552, 1554, and 1556 are grouped, as illustrated in FIG. 15B, the control module 170 releases the grouping of the icons 1551, 1552, 1554, and 1556. Further, the control module 170 may arrange the pages 1512, 1514, and 1516 including the icons 1551, 1552, 1554, and 1556 according to their order before the grouping illustrated in FIG. 15B.

According to an embodiment of the present invention, the first input for primarily grouping the icons 1551, 1552, 1554, and 1556 or the second input for releasing the primary grouping may be a touch input made by the user through the display implemented by a touch panel. The first input may be a pinch-in input and the second input may be a pinch-out input. In FIG. 15C, only the icons 1551, 1552, 1554, and 1556 are grouped. In FIG. 15B, icons 1551, 1552, 1554, and 1556 of which pages are adjacent to each other are grouped, that is, the first icon 1551 and the second icon 1552 are grouped into one page, and the third icon 1555 and the fourth icon 1556 are grouped into one page (primary grouping). In FIG. 15C, objects (for example, icons or widgets) included in all pages 1512 to 1516 having the same attribute are grouped (secondary grouping). A user input for the secondary grouping, that is a third input may be an input in a state where the objects are primarily grouped, as illustrated in FIG. 15B. As illustrated in FIG. 15C, when the third input is made into the electronic device 101 in a state where the objects are primarily grouped, the control module 170 groups objects having the same attribute, which are included on all pages, regardless of the proximity between the objects.

According to an embodiment of the present invention, both the first input and the third input are pinch-in inputs. Further, when the first input and the third input are continuously made by the user through the display 150, the control module 170 controls the electronic device 101 to display only a result of the secondary grouping on the display 150 without displaying a result of the primary grouping. For example, when the user makes continuous pinch-in inputs two times through the display 150, the control module 170 displays the icons included on all pages, such that four icons are displayed on one page regardless of the proximity between the pages. Further, next to the pages including the icons, pages including widgets with respect to all pages may be arranged.

As described above, when the electronic device 101 receives two successive pinch-in inputs from the user through the display 150, the electronic device 101 groups the objects having the same attribute with respect to all pages as illustrated in FIG. 15C.

As a result of the secondary grouping described above, FIG. 15C illustrates the first page 1501 corresponding to the home screen, a second page 1522 including the first to fourth icons 1551, 1552, 1554, and 1556, a third page 1523 including the first widget 1553, and a fourth page 1524 including the second widget 1555.

In FIG. 15C, the pages 1501, 1522, 1523, and 1524 are displayed according to the order of “first page 1501→second page 1522→third page 1523→fourth page 1524→first page 1501”, or may be displayed according to the opposite order thereof. Further, as described above, the control module 170 groups the first to fourth icons 1551, 1552, 1554, and 1556, the first widget 1553, and the second widget 1555 into one group such as Favorite apps & Widget+Apps.

When a fourth input for releasing the secondary grouping is made in a state where the icons 1551, 1552, 1554, and 1556 are secondarily grouped as illustrated in FIG. 15C, the control module 170 releases the secondary grouping of the icons 1551, 1552, 1554, and 1556. Further, the control module 170 may arrange the pages 1501, 1512, 1514, and 1516, including the icons 1551, 1552, 1554, and 1556, according to the order before the secondary grouping, as illustrated in FIG. 15B.

According to an embodiment of the present invention, the third input for grouping the icons 1551, 1552, 1554, and 1556 or the fourth input for releasing the grouping is a touch input made by the user through the display implemented by a touch panel. The first input and the third input may be pinch-in inputs, and the second input and the fourth input may be pinch-out inputs. When the fourth input and the second input are successively made in a state where the secondary grouping is performed as illustrated in FIG. 15C, the control module 170 returns to a state before the objects are primarily and secondarily grouped. That is, when the fourth input and the second input are successively made, the control module 170 may change the secondarily grouped objects illustrated in FIG. 15C into the objects before the grouping, as illustrated in FIG. 15A.

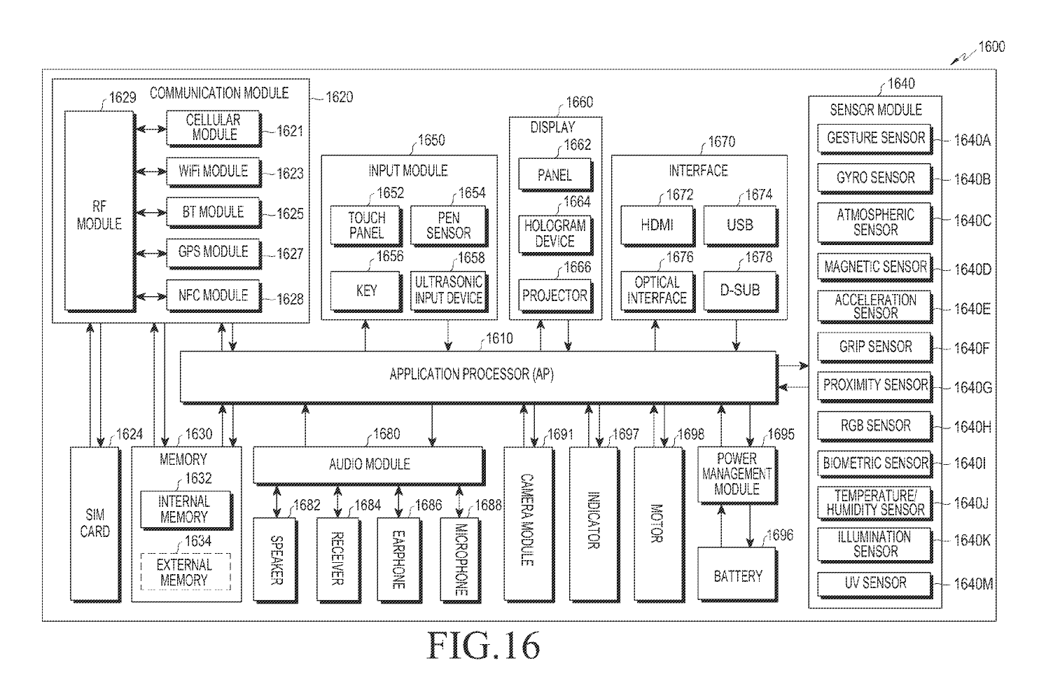

FIG. 16 is a block diagram of an electronic device, according to an embodiment of the present invention. An electronic device 1600 may constitute, for example, all or a part of the electronic device 101 shown in FIG. 1. Referring to FIG. 16, the electronic device 1600 includes at least one Application Processor (AP) 1610, a communication module 1620, a Subscriber Identifier Module (SIM) card 1624, a memory 1630, a sensor module 1640, an input module 1650, a display 1660, an interface 1670, an audio module 1680, a camera module 1691, a power management module 1695, a battery 1696, an indicator 1697, and a motor 1698.

The AP 1610 may control a plurality of hardware or software components connected to the AP 1610 by driving an operating system or an application program, process various pieces of data including multimedia data, and perform calculations. The AP 1610 may be implemented by, for example, a System on Chip (SoC). According to an embodiment of the present invention, the AP 1610 may further include a Graphic Processing Unit (GPU).

The communication module 1620 (for example, the communication interface 160) may perform data transmission/reception in communication between the electronic device 1600 (for example, the electronic device 101) and other electronic devices (for example, the external electronic device 104 or the server 106) connected to the electronic device 1600 through a network. According to an embodiment of the present invention, the communication module 1620 includes a cellular module 1621, a Wi-Fi module 1623, a BT module 1625, a GPS module 1627, an NFC module 1628, and a Radio Frequency (RF) module 1629.

The cellular module 1621 may provide a voice call, a video call, a message service, or an Internet service through a communication network (for example, LTE, LTE-A, CDMA, WCDMA, UMTS, WiBro, GSM, or the like). Also, the cellular module 1621 may distinguish between and authenticate electronic devices in a communication network using, for example, a subscriber identification module (for example, the SIM card 1624). According to an embodiment of the present invention, the cellular module 1621 may perform at least some of the functions which can be provided by the AP 1610. For example, the cellular module 1621 may perform at least the part of multimedia control functions.

According to an embodiment of the present invention, the cellular module 1621 may include a Communication Processor (CP). Further, the cellular module 1621 may be implemented by, for example, an SoC. Although FIG. 16 illustrates that the components such as the cellular module 1621, the memory 1630, and the power management module 1695 are separate from the AP 1610, the AP 1610 may include at least some of the above-described components in alternate embodiments of the present invention.

The AP 1610 or the cellular module 1621 may load a command or data received from at least one of a non-volatile memory and other components connected to each of the AP 1610 and the cellular module 1621, to a volatile memory and process the loaded command or data. Further, the AP 1610 or the cellular module 1621 may store data received from at least one of the other components or created by at least one of the other components in a non-volatile memory.

Each of the Wi-Fi module 1623, the BT module 1625, the GPS module 1627, and the NFC module 1628 may include, for example, a processor for processing data transmitted/received through the corresponding module. In FIG. 16, the cellular module 1621, the WiFi module 1623, the BT module 1625, the GPS module 1627, and the NFC module 1628 are illustrated as blocks separated from each other, but two or more of the cellular module 1621, the WiFi module 1623, the BT module 1625, the GPS module 1627, and the NFC module 1628 may be included in one Integrated Chip (IC) or one IC package. For example, at least some of the processors corresponding to the cellular module 1621, the Wi-Fi module 1623, the BT module 1625, the GPS module 1627, and the NFC module 1628, respectively, may be implemented by a single SoC.

The RF module 1629 may transmit/receive data, for example, an RF signal. Although not illustrated, the RF module 1629 may include, for example, a transceiver, a Power Amp Module (PAM), a frequency filter, a Low Noise Amplifier (LNA), or the like. Further, the RF module 1629 may further include a component, such as a conductor, a conductive wire or the like, for transmitting/receiving an electromagnetic wave in a free space in wireless communication. Although the cellular module 1621, the Wi-Fi module 1623, the BT module 1625, the GPS module 1627, and the NFC module 1628 are illustrated to share one RF module 1629 in FIG. 16, at least one of the cellular module 1621, the Wi-Fi module 1623, the BT module 1625, the GPS module 1627, and the NFC module 1628 may transmit/receive the RF signal through a separate RF module.

The SIM card 1624 may be a card including a subscriber identification module, and may be inserted into a slot formed in a particular portion of the electronic device. The SIM card 1624 may include unique identification information (for example, Integrated Circuit Card IDentifier (ICCID)) or subscriber information (for example, International Mobile Subscriber Identity (IMSI)).

The memory 1630 (for example, memory 130) may include an internal memory 1632 or an external memory 1634. The internal memory 1632 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment of the present invention, the internal memory 1632 may be a Solid State Drive (SSD). The external memory 1634 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 1634 may be functionally connected to the electronic device 1600 through various interfaces. According to an embodiment of the present invention, the electronic device 1600 may further include a storage device (or storage medium) such as, for example, a hard drive.

The sensor module 1640 may measure a physical quantity or detect an operation state of the electronic device 1600, and may convert the measured or detected information to an electronic signal. The sensor module 1640 includes, for example, at least one of a gesture sensor 1640A, a gyro sensor 1640B, an atmospheric pressure sensor 1640C, a magnetic sensor 1640D, an acceleration sensor 1640E, a grip sensor 1640F, a proximity sensor 1640G, a color sensor 1640H (for example, Red, Green, and Blue (RGB) sensor), a biometric sensor 1640I, a temperature/humidity sensor 1640J, an illumination sensor 1640K, and an Ultra Violet (UV) sensor 1640M. Additionally or alternatively, the sensor module 1640 may include, for example, an E-nose sensor, an ElectroMyoGraphy (EMG) sensor, an ElectroEncephaloGram (EEG) sensor, an ElectroCardioGram (ECG) sensor, an InfraRed (IR) sensor, an iris sensor, a fingerprint sensor, and the like. The sensor module 1640 may further include a control circuit for controlling one or more sensors included therein.

The input device 1650 includes a touch panel 1652, a (digital) pen sensor 1654, a key 1656, or an ultrasonic input device 1658. The touch panel 1652 may recognize a touch input through at least one of, for example, a capacitive type, a resistive type, an infrared type, and an ultrasonic type. Further, the touch panel 1652 may further include a control circuit. The capacitive type touch panel may recognize physical contact or proximity. The touch panel 1652 may further include a tactile layer that provides a tactile reaction to a user.

The (digital) pen sensor 1654 may be implemented, for example, using a method identical or similar to a method of receiving a touch input of a user, or using a separate recognition sheet. The key 1656 may include, for example, a physical button, an optical key, or a keypad. The ultrasonic input device 1658 is a device that can detect an acoustic wave by a microphone (for example, a microphone 1688) of the electronic device 1600 through an input tool generating an ultrasonic signal to identify data, and can perform wireless recognition. According to an embodiment of the present invention, the electronic device 1600 may also receive a user input from an external device (for example, a computer or a server) connected thereto, using the communication module 1620.

The display 1660 (for example, the display 160) includes a panel 1662, a hologram device 1664, or a projector 1666. The panel 1662 may be, for example, a Liquid Crystal Display (LCD), Active-Matrix Organic Light Emitting Diode (AM-OLED), or the like. The panel 1662 may be embodied to be, for example, flexible, transparent, or wearable. The panel 1662 may be also configured as one module together with the touch panel 1652. The hologram device 1664 may show a stereoscopic image in the air by using interference of light. The projector 1666 may project light onto a screen to display an image. For example, the screen may be located inside or outside the electronic device 1600. According to an embodiment of the present invention, the display 1660 may further include a control circuit for controlling the panel 1662, the hologram device 1664, or the projector 1666.

The interface 1670 includes, for example, a High-Definition Multimedia Interface (HDMI) 1672, a Universal Serial Bus (USB) 1674, an optical interface 1676, or a D-subminiature (D-sub) 1678. The interface 1670 may be included in, for example, the communication interface 160 illustrated in FIG. 1. Additionally or alternatively, the interface 1670 may include, for example, a Mobile High-definition Link (MHL) interface, a Secure Digital (SD) card/Multi-Media Card (MMC) interface, or an Infrared Data Association (IrDA) standard interface.

The audio module 1680 may bidirectionally convert a sound and an electronic signal. At least some components of the audio module 1680 may be included in, for example, the input/output interface 140 illustrated in FIG. 1. The audio module 1680 may process voice information input or output through, for example, a speaker 1682, a receiver 1684, earphones 1686, a microphone 1688, or the like.

The camera module 1691 is a device that may photograph a still image and a video. According to an embodiment of the present invention, the camera module 1691 may include one or more image sensors (for example, a front sensor or a rear sensor), a lens, an Image Signal Processor (ISP), or a flash.

The power management module 1695 may manage power of the electronic device 1600. Although not illustrated, the power management module 1695 may include, for example, a Power Management Integrated Circuit (PMIC), a charger Integrated Circuit (IC), or a battery or fuel gauge.

The PMIC may be mounted to, for example, an integrated circuit or an SoC semiconductor. Charging methods may be classified into a wired charging method and a wireless charging method. The charger IC may charge a battery and prevent over voltage or over current from being flowed from a charger. According to an embodiment of the present invention, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery gauge may measure, for example, a remaining quantity of the battery 1696, or a voltage, a current, or a temperature during the charging. The battery 1696 may store or generate electricity, and may supply power to the electronic device 1600 using the stored or generated electricity. The battery 1696 may include, for example, a rechargeable battery or a solar battery.

The indicator 1697 may display a particular status of the electronic device 1600 or a part thereof (for example, the AP 1610), for example, a booting status, a message status, a charging status, or the like. The motor 1698 may convert an electrical signal into a mechanical vibration. The electronic device 1600 may include a processing unit (for example, GPU) for supporting a mobile TV function. The processing unit for supporting the mobile TV may process media data according to a standard of DMB, DVB, media flow, or the like.

The above-described components of the electronic device, according to various embodiments of the present invention, may be formed of one or more components, and a name of a corresponding component element may be changed based on the type of electronic device. The electronic device may include one or more of the aforementioned components or may further include other additional components, or some of the aforementioned components may be omitted. Further, some components of the electronic device, according to various embodiments of the present invention, may be combined to form a single entity, and thus, may equivalently execute functions of the corresponding elements prior to the combination.

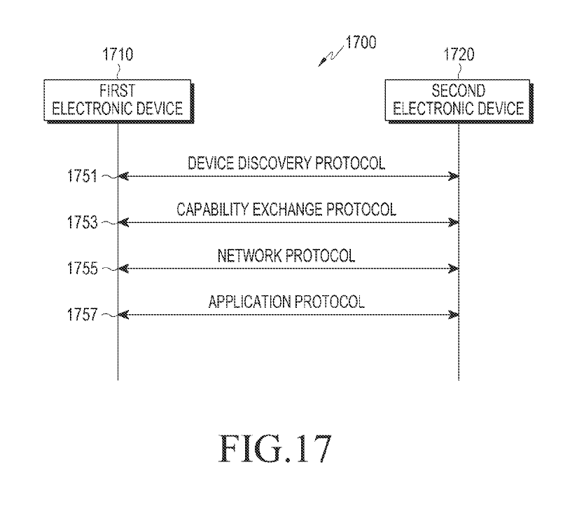

FIG. 17 is a diagram illustrating a communication protocol between a plurality of electronic devices, according to various embodiments of the present disclosure.

Referring to FIG. 17, a communication protocol 1700 includes a device discovery protocol 1751, a capability exchange protocol 1753, a network protocol 1755, and an application protocol 1757.

According to an embodiment of the present invention, the device discovery protocol 1751 is a protocol that allows electronic devices (for example, first electronic device 1710 or second electronic device 1720) to detect an external electronic device that can be connected thereto or connect the found external electronic device thereto. For example, the first electronic device 1710 (for example, the electronic device 101) may detect, as a device that communicates with the first electronic device 1710, the second electronic device 1720 (for example, the external electronic device 104) by using the device discovery protocol 1751 through a communication method (for example, Wi-Fi, BT, USB, or the like), which can be used by the first electronic device 1710. For a communication connection with the second electronic device 1720, the first electronic device 1710 may acquire identification information of the second electronic device 1720 detected through the device discovery protocol 1751 and store the acquired identification information. For example, the first electronic device 1710 may establish the communication connection with the second electronic device 1720 at least based on the identification information.

According to an embodiment of the present invention, the device discovery protocol 1751 may be a protocol for mutual authentication among a plurality of electronic devices. For example, the first electronic device 1710 may perform authentication between the first electronic device 1710 and the second electronic device 1720 based on communication information (for example, a Media Access Control (MAC) address, a Universally Unique IDentifier (UUID), a SubSystem IDentification (SSID), and an Information Provider (IP) address) for the connection with the second electronic device 1720.

According to an embodiment of the present invention, the capability exchange protocol 1753 is a protocol for exchanging information related to a service function that is supported by at least one of the first electronic device 1710 and the second electronic device 1720. For example, the first electronic device 1710 and the second electronic device 1720 may exchange information related to a service function currently provided by each of the first electronic device 1710 and the second electronic device 1720 through the capability exchange protocol 1753. The exchangeable information may include identification information indicating a particular service among a plurality of services that can be supported by the first electronic device 101 or the external electronic device 104. For example, the first electronic device 1710 may receive, from the second electronic device 1720, identification information of a particular service provided by the second electronic device 1720 through the capability exchange protocol 1753. The first electronic device 1710 may determine whether the particular service can be supported by the first electronic device 1710 itself based on the received identification information.

According to an embodiment of the present invention, the network protocol 1755 may be a protocol for controlling flows of data, which are transmitted/received to provide a service linked between the electronic devices (for example, the first electronic device 1710 and the second electronic device 1720), which are connected to communicate with each other. For example, at least one of the first electronic device 1710 and the second electronic device 1720 may control an error or data quality by using the network protocol 1755. Additionally or alternatively, the network protocol 1755 may determine a transport format of data transmitted/received between the electronic device 1710 and the second electronic device 1720. Further, at least one of the electronic device 1710 and the second electronic device 1720 may at least manage a session (for example, a session connection or a session termination) for a data exchange between the electronic devices by using the network protocol 1755.

According to an embodiment of the present invention, the application protocol 1757 may be a protocol for providing a process or information for exchanging data related to a service provided to an external electronic device. For example, the first electronic device 1710 (for example, the electronic device 101) may provide a service to the second electronic device 1720 (for example, the electronic device 104 or the server 106) through the application protocol 1757.

According to an embodiment of the present invention, the communication protocol 1700 may include a standard communication protocol, a communication protocol designated by an individual or organization (for example, a communication protocol self-designated by a communication device manufacturing company or a network supplying company), or a combination thereof.

The term “module” used herein may refer to, for example, a “unit” including one of hardware, software, and firmware, or a combination of two or more of the hardware, software, and firmware. The term “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” may include at least one of an Application-Specific Integrated Circuit (ASIC) chip, a Field-Programmable Gate Arrays (FPGAs), and a programmable-logic device for performing operations, which have been known or are to be developed hereafter.

According to an embodiment of the present invention, at least part of a device (for example, modules or functions thereof) or a method (for example, operations) may be embodied by, for example, an instruction stored in a computer readable storage medium provided in a form of a programming module. When a command is executed by one or more processors (for example, the processor 210), the one or more processors may execute a function corresponding to the command. The computer-readable storage medium may be, for example, the memory 130. At least some of the programming modules may be implemented (for example, executed) by, for example, the processor 210. At least a part of the programming module may include, for example, a module, a program, a routine, a set of instructions and/or a process for performing one or more functions.

The computer-readable recording medium may include magnetic media such as, for example, a hard disk, a floppy disk, and a magnetic tape, optical media such as a CD-ROM and a DVD, magneto-optical media such as a floptical disk, and hardware devices specially configured to store and perform a program instruction (for example, programming module), such as a ROM, a RAM, a flash memory, and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

A module or a programming module, according to an embodiment of the present invention, may include at least one of the described component elements, a few of the component elements may be omitted, or additional component elements may be included. Operations executed by a module, a programming module, or other component elements, according to embodiments of the present invention, may be executed sequentially, in parallel, repeatedly, or in a heuristic manner. Furthermore, some operations may be executed in a different order or may be omitted, or other operations may be added.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for rearranging pages comprising one or more objects in an electronic device, the method comprising:
displaying one or more pages having one or more objects on a display of the electronic device;
receiving a first input;
in response to the first input: displaying at least one or more objects having a same attribute in a page, wherein the at least one or more objects are next to each other;
receiving a second input;
in response to the second input, changing a position of the at least one or more objects;
receiving a third input; and
in response to the third input, rearranging the one or more pages according to the changed position.

2. The method of claim 1, wherein the first user input is for grouping the at least one or more objects,
wherein displaying the one or more pages having the one or more objects on the display of the electronic device comprises changing an arrangement of the at least one or more objects such that two or more objects having the same attribute are close to each other.

3. The method of claim 2, wherein changing the arrangement of the at least one or more objects comprises:
determining whether the two or more objects that have the same attribute can be included on a single page; and
when the two or more objects can be included on the single page, editing the at least one or more objects or one or more pages including the two or more objects such that the two or more objects are included on the single page.

4. The method of claim 3, further comprising:
when the two or more objects can not be included on the single page, editing the at least one or more objects or the one or more pages including the at least one or more objects such that the at least one or more objects are included on pages that are close to each other.

5. The method of claim 1, wherein at least one of the first input, the second input or the third input is a pinch-in input.

6. The method of claim 1, further comprising:
receiving a forth user input; and
editing the pages or the at least one or more objects such that two or more objects having the same attribute are included on pages that are close to each other.

7. The method of claim 1, further comprising:
receiving a fourth user input for releasing a grouping of the at least one or more objects; and
changing an arrangement of the at least one or more objects such that each of the at least one or more objects included in a single page are moved to individual respective pages.

8. The method of claim 7, wherein the fourth user input is a pinch-out input.

9. An electronic device for rearranging pages comprising one or more objects, the electronic device comprising:
a display configured to display one or more pages having one or more objects; and
a control module configured to:
in response to a first input, control the display to display at least one or more objects having a same attribute in a page, wherein the at least one or more objects are next to each other,
in response to a second input, change a position of the at least one or more objects, and
in response to a third input, rearranging the one or more pages according to the changed position.

10. The electronic device of claim 9, wherein, the first user input is for grouping of the at least one or more objects,
wherein the control module changes an arrangement of the at least one or more objects such that two or more objects having the same attribute are close to each other.

11. The electronic device of claim 10, wherein the control module determines whether the two or more objects that have the same attribute can be included on a single page, and, when the two or more objects can be included on the single page, edits the at least one or more objects or one or more pages including the two or more objects such that the two or more objects are included on the single page.

12. The electronic device of claim 11, wherein the control module further configured to edit the at least one or more objects or the one or more pages including the two or more objects such that the two or more objects are included on pages that are close to each other when the two or more objects can not included on the single page.

13. The electronic device of claim 9, wherein at least one of the first user input, the second user input, or the third user input is a pinch-in input.

14. The electronic device of claim 9, wherein the control module further configured to, in response to a fourth user input, edit the pages or the at least one or more objects such that two or more objects having the same attribute are included on pages that are close to each other.

15. The electronic device of claim 9, wherein the control module further configured to, in response to a fourth user input for releasing a grouping of the at least one or more objects, change an arrangement of the at least one or more objects such that each of objects included in a single page are moved to individual respective pages.

16. The electronic device of claim 15, wherein the fourth user input is a pinch-out input.
